(19) United States
(12) Patent Application Publication
(10) Pub. No.: US 2018/0004324 A1
(43) Pub. Date: Jan. 4, 2018

(54) TOUCH SENSING DEVICE, PEN, AND METHOD FOR MEASURING POSITION

(71) Applicant: Samsung Electronics Co., Ltd., Suwon-si (KR)

(72) Inventor: Sung-Soo PARK, Suwon-si (KR)

(21) Appl. No.: 15/638,945

(22) Filed: Jun. 30, 2017

(30) Foreign Application Priority Data
Jul. 1, 2016 (KR) 10-2016-0083422

(51) Int. Cl. G06F 3/044; G06F 3/0354; G02F 1/1333; G06F 3/045; G06F 3/041

(52) U.S. Cl. CPC G06F 3/044; G06F 3/045; G06F 3/0416; G02F 1/13338; G06F 3/03545; G06F 3/0412

(57) ABSTRACT

A touch sensing device for determining a position of a pen the touch sensing device and a method therefor are provided. The touch sensing device includes electrodes configured to output electrical signals using an electric field generated from the pen, a receiving circuit configured to receive the electrical signals from the electrodes, and a control circuit. The control circuit may be configured to determine a type of the pen based on the electrical signals received from the receiving circuit, and measure the position of the pen according to the determined type of the pen.

### CROSS-REFERENCE TO RELATED APPLICATION(S)

This application claims the benefit under 35 U.S.C. §119(a) of a Korean patent application filed on Jul. 1, 2016 in the Korean Intellectual Property Office and assigned Serial number 10-2016-0083422, the entire disclosure of which is hereby incorporated by reference.

### TECHNICAL FIELD

The present disclosure relates to touch sensing devices, pens, and methods for measuring positions.

### BACKGROUND

Smartphones or tablet personal computers (PCs) are widely in use, and vigorous development efforts are underway for embedded devices for measuring the position of contact. A smartphone or tablet PC is primarily equipped with a touchscreen. The user may designate particular coordinates on the touchscreen using his finger or a pen. The user may enter a particular signal to the smartphone by designating the particular coordinates on the touchscreen.

The touchscreen may be operated in an electrical, infrared (IR), or ultrasonic manner Examples of touchscreens operated in an electrical manner include R-type touchscreens (resistive touchscreens) or C-type touchscreens (capacitive touchscreens). R-type touchscreens have been used widely according to the related art, which may simultaneously recognize the user's finger and pen. However, R-type touchscreens suffer from problems with reflection by the air layer between the indium tin oxide (ITO) layers. Specifically, the ITO layer positioned between the ITO layers may deteriorate the transmittance of light from the display and increase the reflection of external light.

Accordingly, C-type touchscreens are nowadays being adopted a lot. C-type touchscreens are operated in such a manner as to sense a difference in the capacitance of the transparent electrode that is caused by contact of an object. However, C-type touchscreens may be incapable of physically distinguishing between finger and pen, causing an operational error by an unintentional contact with the hand when the pen is being used.

Examples of conventional technology to address such shortcomings include a processing method using a software program that may distinguish between hand and pen according to the area of contact and a method for adding a separate location measuring device, such as an electro-magnetic resonance (EMR) method that uses magnetic fields, to C-type touchscreens. Also available are active stylus techniques in which the position of the pen is measured by receiving an electric field generated from the pen and passive pen techniques that employ electrically-coupled resonance (ECR).

As such, various types of pens are under development, such as ones using magnetic fields, e.g., EMR-based pens or ones using electric fields, e.g., active styluses or ECR pens. Such pens may be divided into active-type pens which include an embedded power source and passive-type pens which do not.

The above information is presented as background information only to assist with an understanding of the present disclosure. No determination has been made, and no assertion is made, as to whether any of the above might be applicable as prior art with regard to the present disclosure.

### SUMMARY

As set forth above, pens of the related art are classified depending on various types and schemes, raising an issue in compatibility with touch sensing devices having a touch panel. For example, touch panels corresponding to active pens of the type of using electric fields might not determine the position of a passive pen that is of an electrically-coupled resonance (ECR) type.

Therefore, a need exists for developing a touch sensing device capable of determining the type of various pens and operating as per the determined type and a method for operating the touch sensing device.

In accordance with an aspect of the present disclosure, a touch sensing device for determining a position of a pen the touch sensing device is provided. The touch sensing device includes a plurality of electrodes configured to output electrical signals using an electric field generated from the pen, a receiving circuit configured to receive the electrical signals from the plurality of electrodes, and a control circuit configured to determine a type of the pen, among a plurality of types of pens, based on the electrical signals received from the receiving circuit, and measure the position of the pen according to the determined type of the pen.

In accordance with another aspect of the present disclosure, a pen is provided, The pen includes a receiving electrode configured to receive a signal generated from a touch sensing device through a capacitive coupling with an electrode of the touch sensing device, a receiving circuit configured to receive an electrical signal of the touch sensing device from the receiving electrode, and a pen signal generating circuit configured to generate a pen signal of at least one of a pattern or a frequency which has been set according to the electrical signal received from the receiving circuit.

In accordance with another embodiment of the present disclosure, a method of operating a touch sensing device to determine a position of a pen is provided. The method includes outputting electrical signals from a plurality of electrodes, respectively, of the touch sensing device using a pen signal generated from the pen, determining a type of the pen, among a plurality of types of pens, based on the electrical signals, and measuring the position of the pen according to the determined type of the pen.

In accordance with another embodiment of the present disclosure, a method for operating a pen is provided. The method includes receiving a signal generated from a touch sensing device through a capacitive coupling with an electrode of the touch sensing device to generate a pen signal, and generating a pen signal including at least one of a pattern or a frequency set according to the received signal.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, wherein:

FIG. 1 is a concept view illustrating a touch sensing device and a pen according to an embodiment of the present disclosure;

FIG. 2A is a block diagram illustrating a detailed configuration of a processing circuit according to an embodiment of the present disclosure;

FIGS. 2B, 2C, 2D, 2E, and 2F are concept views illustrating a method for determining the position of a passive pen according to various embodiments of the present disclosure;

FIG. 2G is a view illustrating various waveforms for determining the position of a passive pen according to an embodiment of the present disclosure;

FIG. 2H is a concept view illustrating a method for determining the position of an active pen according to an embodiment of the present disclosure;

FIG. 3 is a concept view illustrating a structure of a pen according to an embodiment of the present disclosure;

FIG. 4 is a concept view illustrating an active pen including a power source according to an embodiment of the present disclosure;

FIG. 5 is a flowchart illustrating operations of a touch sensing device according to an embodiment of the present disclosure;

FIG. 6A is a view illustrating waveforms of signals transmitted and received by a touch sensing device when an active pen is nearby according to an embodiment of the present disclosure;

FIG. 6B is a view illustrating waveforms of signals transmitted and received by a touch sensing device when a passive pen is nearby according to an embodiment of the present disclosure;

FIG. 7 is a flowchart illustrating an operational method according to an embodiment of the present disclosure;

FIG. 8A is a view illustrating waveforms of signals transmitted and received by a touch sensing device when a passive pen is nearby according to an embodiment of the present disclosure;

FIG. 8B is a view illustrating waveforms of signals transmitted and received by a touch sensing device when an active pen is nearby according to an embodiment of the present disclosure;

FIGS. 9A, 9B, 9C, 9D, and 9E are views illustrating waveforms by various active pens according to various embodiments of the present disclosure;

FIG. 10 is a block diagram illustrating a receiving circuit according to an embodiment of the present disclosure;

FIG. 11 is a block diagram illustrating a receiving circuit according to an embodiment of the present disclosure;

FIGS. 12A and 12B are block diagrams illustrating receiving circuits according to various embodiments of the present disclosure;

FIG. 13 is a flowchart illustrating operations of a touch sensing device according to an embodiment of the present disclosure;

FIGS. 14 and 15 are concept views illustrating pens according to various embodiments of the present disclosure;

FIG. 16 is a flowchart illustrating operations of a touch sensing device according to an embodiment of the present disclosure;

FIG. 17 is a flowchart illustrating a method for operating a pen according to an embodiment of the present disclosure;

FIG. 18 is a block diagram illustrating a touch sensing device and a network according to an embodiment of the present disclosure;

FIG. 19 is a block diagram illustrating a touch sensing device according to an embodiment of the present disclosure; and

FIG. 20 is a block diagram illustrating a program module according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, and C” may mean a generic-purpose processor (e.g., a central processing unit (CPU) or application processor (AP)) that may perform the operations by executing one or more software programs stored in a memory device or a dedicated processor (e.g., an embedded processor) for performing the operations.

For example, the touch sensing device according to embodiments of the present disclosure may be included in at least one of, e.g., a smartphone, a tablet personal computer (PC), a mobile phone, a video phone, an e-book reader, a desktop PC, a laptop computer, a netbook computer, a workstation, a server, a personal digital assistant (PDA), a portable multimedia player (PMP), a Moving Picture Experts Group (MPEG-1 or MPEG-2) audio layer 3 (MP3) player, a medical device, a camera, or a wearable device. The touch sensing device may be included in at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments, the touch sensing device may be included in at least one of, e.g., a television (TV), a digital video disc (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, the touch sensing device may be included in at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs), point of sales (POS) devices, or internet of things (IoT) devices (e.g., a bulb, various sensors, a sprinkler, a fire alarm, a thermostat, a street light, a toaster, fitness equipment, a hot water tank, a heater, or a boiler). According to various embodiments of the disclosure, the touch sensing device may be included in at least one of, e.g., part of a piece of furniture, building/structure or vehicle, an electronic board, an electronic signature receiving device, a projector, or various measurement devices (e.g., devices for measuring water, electricity, gas, or electromagnetic waves). According to embodiments of the present disclosure, the touch sensing device may be flexible or may be a combination of two or more of the above-enumerated electronic devices. According to an embodiment of the present disclosure, the touch sensing device is not limited to the above-listed devices. As used herein, the term “user” may denote a human or another device (e.g., an artificial intelligent touch sensing device) using the touch sensing device.

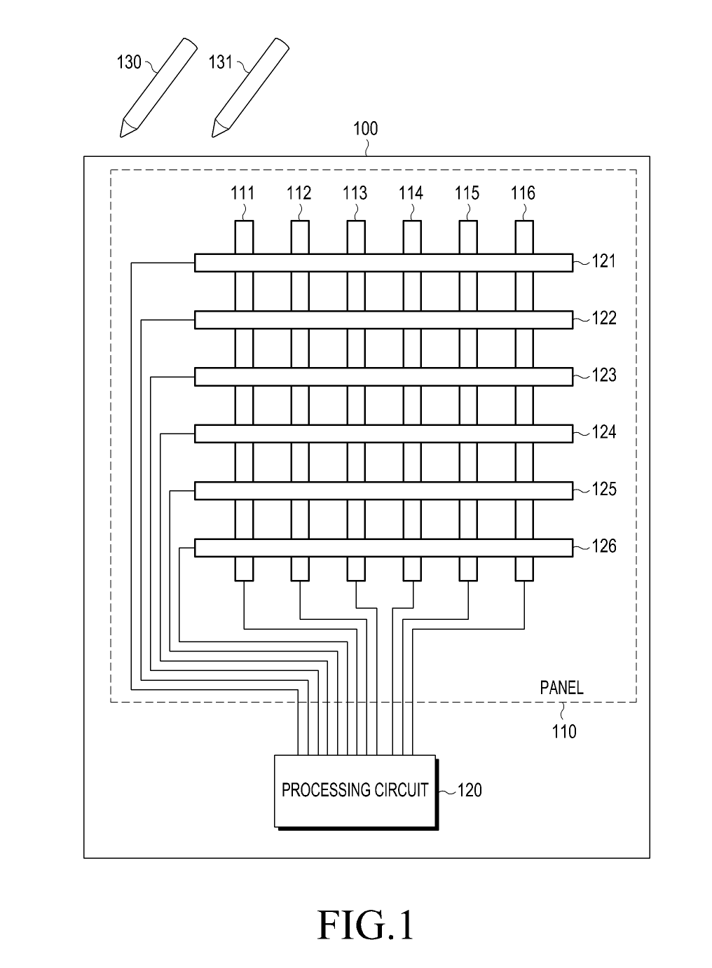

FIG. 1 is a concept view illustrating a touch sensing device and a pen according to an embodiment of the present disclosure.

Referring to FIG. 1, a touch sensing device 100 may include a panel 110 and a processing circuit 120 (e.g., at least one processor). A plurality of electrodes 111 to 116 and 121 to 126 may be arranged on the panel 110. Vertically elongate electrodes 111 to 116 may be ones for measuring the position of a pen 130 or 131 in a horizontal direction, and horizontally elongate electrodes 121 to 126 may be ones for measuring the position of the pen 130 or 131 in a vertical direction. The electrodes 111 to 116 and 121 to 126 may be formed of a transparent conductor, such as indium tin oxide (ITO) or a metal mesh. However, it will readily be appreciated by one of ordinary skill in the art that the electrodes are not limited thereto as long as they are configured to be transparent and conductive. Although the vertically elongate rectangular electrodes 111 to 116 and the horizontally elongate rectangular electrodes 121 to 126 are shown to be perpendicular to each other in FIG. 1, this is merely an example. For example, the electrodes may also be implemented in other various configurations, such as a diamond pattern or mesh pattern.

The electrodes 111 to 116 and 121 to 126 may be connected with the processing circuit 120. Although now shown, switches may be provided which turn on or off to connect or disconnect the electrodes 111 to 116 and 121 to 126 from the processing circuit 120, which is described below in greater detail. An electric field generated from the pen 130 or 131 may reach near the electrodes 111 to 116 and 121 to 126. The electrodes 111 to 116 and 121 to 126 may generate electrical signals by the surrounding electric field. The electrical signals respectively generated from the electrodes 111 to 116 and 121 to 126 may be input to the processing circuit 120. The electrodes 111 to 116 and 121 to 126, respectively, correspond to channels. The processing circuit 120 may determine the strength of the signals per channel. The processing circuit 120 may determine the position of the pen 130 or 131 using the per-channel strengths, which is described below in further detail.

Meanwhile, the active pen 130 may include a power source, e.g., a battery. Thus, the active pen 130 may generate an electric field using the power from the power source. However, the passive pen 131 does not include a power source. Accordingly, the passive pen 131 receives the electric field from at least one of the electrodes 111 to 116 and 121 to 126, generate a resonance using the received electric field to generate an electric field. Thus, the processing circuit 120 may apply an electrical signal to at least one of the electrodes 111 to 116 and 121 to 126 during, e.g., a first period, so that at least one of the electrodes 111 to 116 and 121 to 126 may generate an electrical field. The processing circuit 120 may also process the electrical signals outputted from the electrodes 111 to 116 and 121 to 126 during, e.g., a second period, to determine the position of the passive pen 131. As set forth above, unlike in the active pen 130, the processing circuit 120 may determine the position of the passive pen 131 by processing the electrical signals outputted from the electrodes 111 to 116 and 121 to 126. In other words, the processing circuit 120 may perform different operations depending on whether the pen is of a passive type or active type. According to an embodiment of the present disclosure, the touch sensing device 100 may determine whether the type of a pen is passive or active and may then operate depending on the determined type of pen. The type of a pen may also be differentiated depending on the type of a signal that the pen generates. According to an embodiment of the present disclosure, the touch sensing device 100 may be operated as per a procedure defined depending on the type of the pen. The determination of the type of a pen and resultant operations are described below in greater detail.

According to an embodiment of the present disclosure, the touch sensing device 100 may include a capacitance variation sensing circuit that may sense contact of a conductive, e.g., a finger. Where the touch sensing device 100 senses contact of a type of pen, the touch sensing device 100 may abstain from determining information regarding the position of the contact of the conductive object by the capacitance variation sensing circuit or transmitting to the control circuit. Accordingly, where the user writes on the touch sensing device 100 with a pen in his hand, the touch sensing device 100 may abstain from processing the contact by the hand. Or, the touch sensing device 100 may also sense contact by a conductive object, e.g., a finger, according to a variation in the capacitance of the electrodes 111 to 116 and 121 to 126 (the capacitance of the electrodes themselves or capacitance between the electrodes). Upon simultaneously sensing contact of the pen and contact of a finger, the touch sensing device 101 may be set to process the contact of the pen while disregarding the contact of the finger.

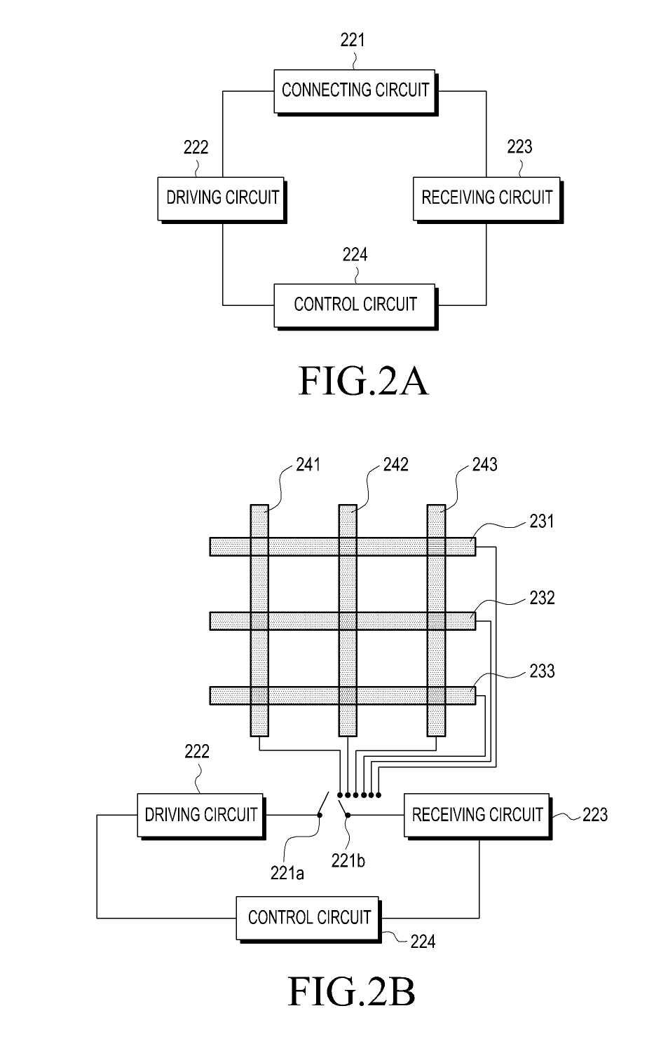

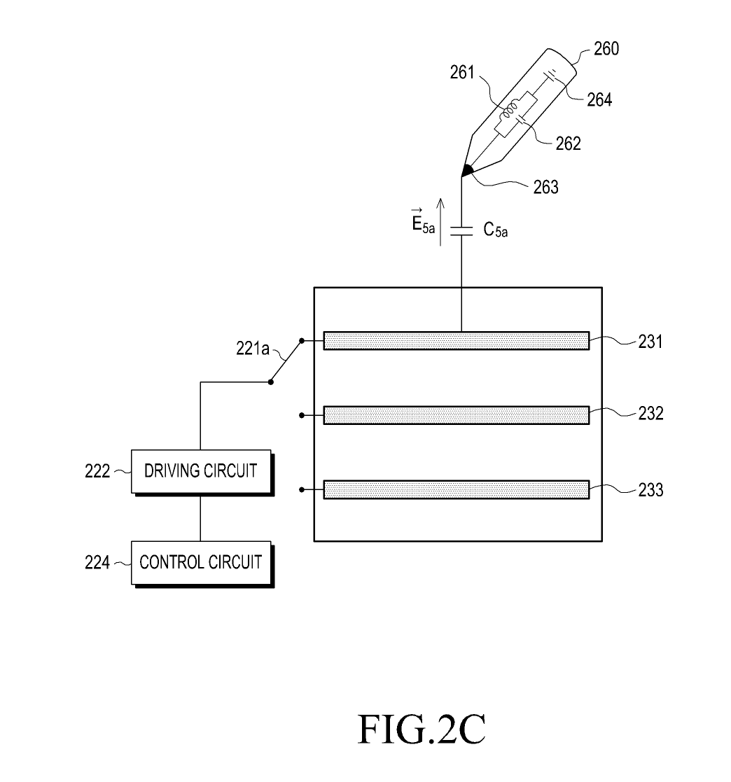

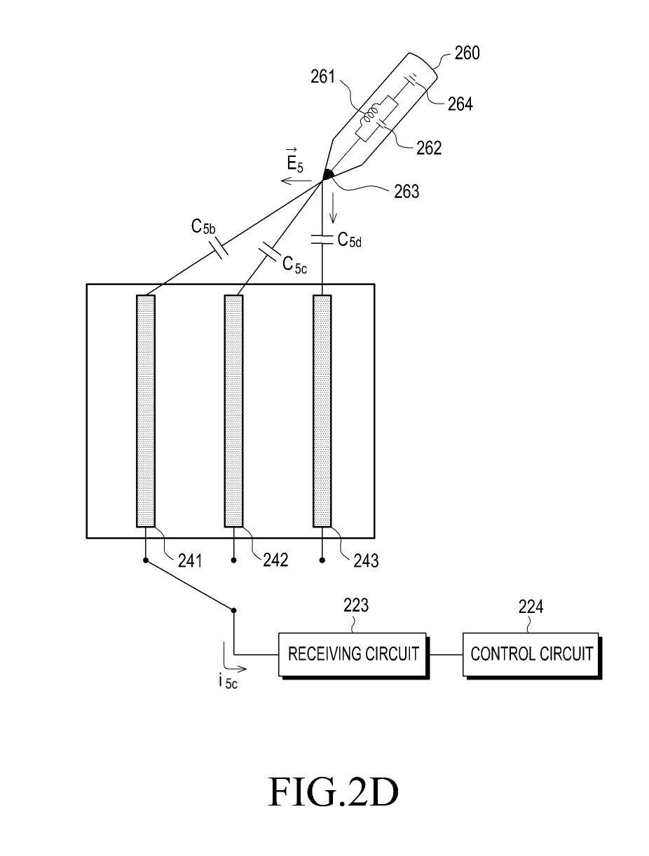

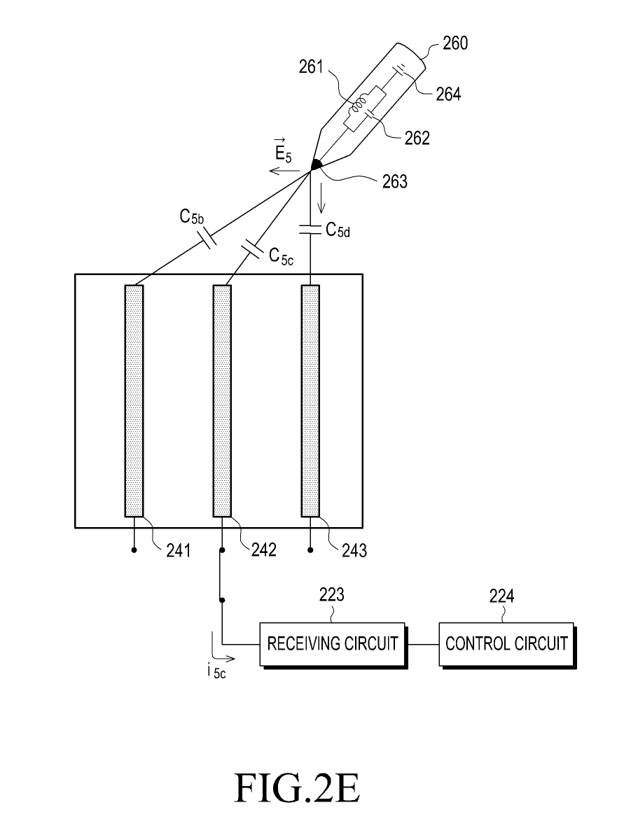

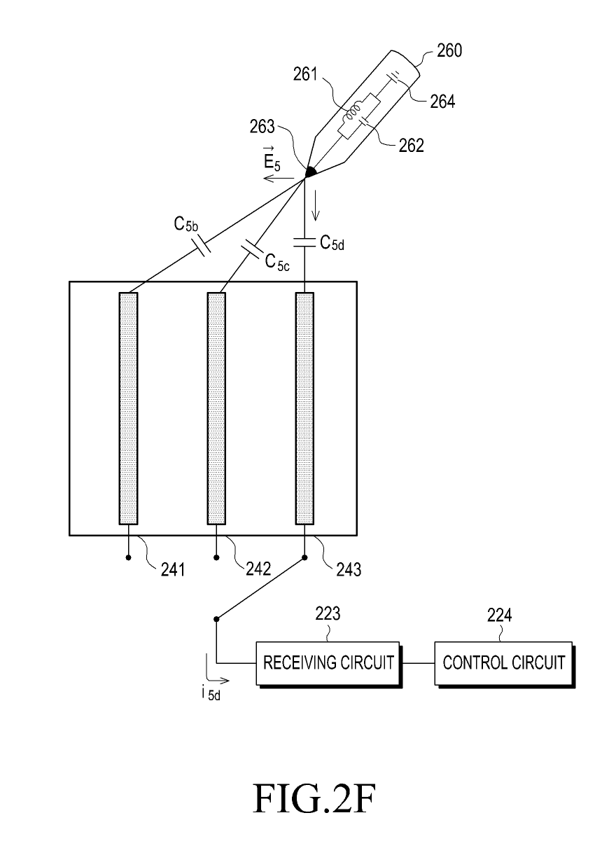

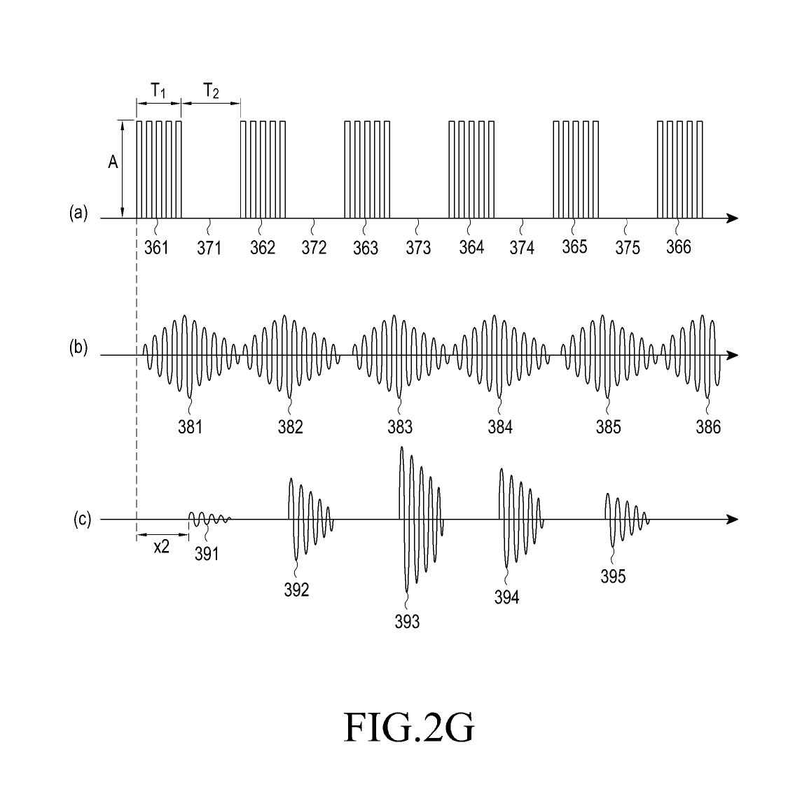

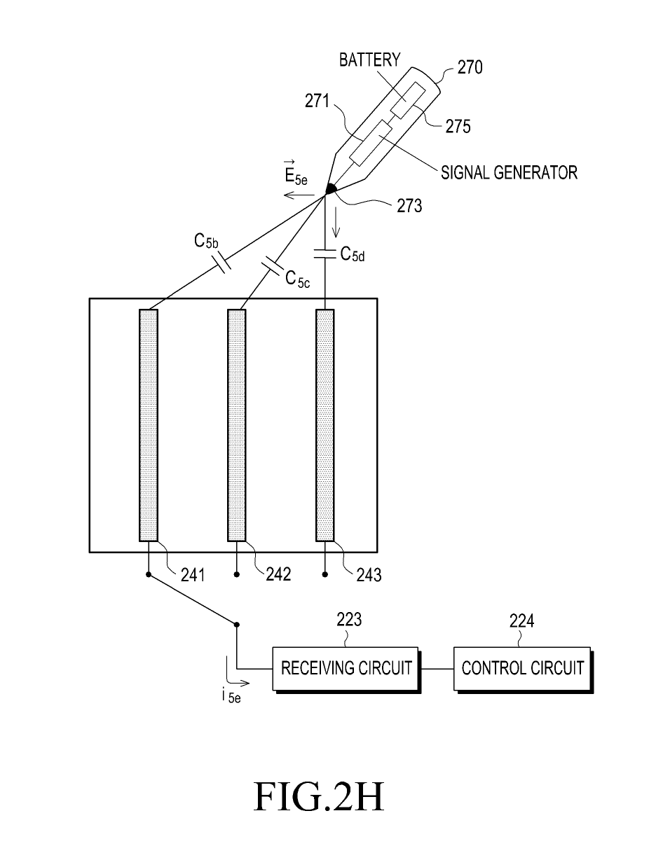

FIG. 2A is a block diagram illustrating a detailed configuration of a processing circuit according to an embodiment of the present disclosure. Touch sensing device 100 may perform particular operation may mean that a control circuit 224 may perform a particular operation, or the control circuit 224 may control other hardware to perform a particular operation.

Referring to FIG. 2A, according to an embodiment of the present disclosure, a processing circuit may include a connecting circuit 221, a driving circuit 222, a receiving circuit 223, and a control circuit 224. The driving circuit 222 may generate an electrical signal. As described above, in order to measure the position of a passive pen, the electrical signal generated from the driving circuit 222 may be provided to at least one of the electrodes through the connecting circuit 221, and the electrode receiving the electrical signal may generate an electric field using the received electrical signal. The connecting circuit 221 may include an on/off switch that connects or disconnects the driving circuit 222 from the electrode or an on/off switch that connects or disconnects the electrode from the receiving circuit 223. Meanwhile, a signal generated from the driving circuit 222 may be used to transfer a signal generation timing or signal pattern-related information to the active pen.

The receiving circuit 223 may receive the electrical signal from the electrode through the connecting circuit 221. The control circuit 224 may determine the position of the pen using the strength of the electrical signal received from the receiving circuit 223. The control circuit 224 may determine the position of the pen using a relative strength of a per-channel electrical signal. Further, the control circuit 224 may control the connecting circuit 221 to connect the driving circuit 222 to at least one electrode.

Now described in greater detail is a method for determining the position of a passive pen with reference to FIGS. 2B to 2F.

FIGS. 2B, 2C, 2D, 2E, and 2F are concept views illustrating a method for determining the position of a passive pen according to various embodiments of the present disclosure.

Referring to FIG. 2B, electrodes 231, 232, 233, 241, 242, and 243 may be connected to the driving circuit 222. The electrodes may be connected to the driving circuit 222 through a switch 221a. The control circuit 224 may control the driving circuit 222 to apply electrical signals to the electrodes 231, 232, 233, 241, 242, and 243. The control circuit 224 may control the switch 221a connected with the driving circuit 222 to connect the driving circuit 222 to the electrodes 231, 232, 233, 241, 242, and 243.

The electrode connected to the driving circuit 222 may be referred to as a driving electrode. The driving electrode may receive an electrical signal, i.e., a driving signal, from the driving circuit 222. The driving electrode may generate an electric field based on the driving signal.

The electrodes 231, 232, 233, 241, 242, and 243 may be connected to the receiving circuit 223. The electrodes 231, 232, 233, 241, 242, and 243 may be connected to the receiving circuit 223 through a switch 221b. The control circuit 224 may control the switch 221b to connect the receiving circuit 223 to the electrodes 231, 232, 233, 241, 242, and 243. The receiving circuit 223 may process an electrical signal received from the connected electrode, and the control circuit 224 may measure the position of the pen using the processed signal. The electrodes 231, 232, 233, 241, 242, and 243 may output an electrical signal, i.e., a receive signal, which is generated by an electric field outputted from the pen.

FIG. 2C is a concept view illustrating an example of measuring the position of a pen by a touch sensing device according to an embodiment of the present disclosure.

Referring to FIG. 2C, the control circuit 224 may control the switch 221a and the driving circuit 222 to apply a driving signal to the driving electrode 231. Meanwhile, the driving electrode 231, along with the conductive tip 263 of the pen 260, may form a capacitance C5a. The driving electrode 231 may form an electric field E5a based on the driving signal from the driving circuit 222 and send a transmit signal to the pen 260. For example, the driving circuit 222 may output driving signals 361 to 366 as shown in FIG. 2G(a) to the driving electrode 231. The driving circuit 222 may output the driving signals 361 to 366 during a first period and stop outputting the driving signals during a second period 371 to 375. Specifically, the driving circuit 222 may output the driving signals 361 to 366 during a driving period T1, i.e., the first period and stop outputting the driving signals during a non-driving period T2, i.e., the second period 371 to 375. The driving circuit 222 may repeat the control of the driving signals during the driving period and the non-driving period. Or, the control circuit 224 may control the setup 221a so that the driving circuit 222 and the driving electrode 231 are connected together during the first period and disconnected from each other during the second period. A ground unit 264 is shown in connection to the resonance circuit 261 or 262.

As shown in FIG. 2D, the conductive tip 263 of the pen, along with a fourth electrode 241, may form a capacitance C5b. The conductive tip 263, along with a fifth electrode 242, may form a capacitance C5c. The conductive tip 263, along with a sixth electrode 243, may form a capacitance C5d. When the driving electrode 231 generates the electric field E5a by the driving signal 361, a resonance circuit 261 or 262 of the pen may generate a resonance using the received signal through a variation in the electric field. For example, the resonance circuit 261 of 262 of the pen may generate a resonance as shown in FIG. 2G(b). FIG. 2G(b) shows a voltage at the conductive tip 263. As shown in FIG. 2G(b), the voltage at the conductive tip 263 may have an alternating current (AC) form whose amplitude may be increased during a period when the driving signal is applied, i.e., the first period. Further, the amplitude of the voltage at the conductive tip 263 may be reduced during a period when the driving signal is not applied, i.e., the second period. Various amplitudes 381-386 are illustrated in FIG. 2G(b). FIG. 2G(c) shows the magnitude of a receive signal received through each electrode and receiving circuit 223. The resonance signal of the pen may be applied to the fourth electrode 241 during a first second period 371. The receiving circuit 223 may generate an electrical signal i5b corresponding to the pen resonance signal received from the fourth electrode 241. At this time, the signal i5b may be in the form denoted by 391 of FIG. 2G(c). The receiving circuit 223 may receive the electrical signal i5b and transfer the electrical signal to the control circuit 224. The control circuit 224 may measure the position of the pen using the received electrical signal i5b. Generally, the pen resonance signal received by each electrode is significantly small as compared with the driving signal 361. Thus, the pen resonance signal may be difficult to effectively receive during the period T1 when the driving signal 361 is generated. Accordingly, it may be effective to receive the pen resonance signal during the non-driving period T2, i.e., the second period 371.

As shown in FIG. 2E, the conductive tip 263 of the pen, together with the fifth electrode 242, may form a capacitance C5c. When the driving electrode 231 generates the electric field E5a by the driving signal 362, the resonance circuit 261 or 262 of the pen may generate a resonance. The pen resonance signal may be a signal i5c having a second waveform 392 of FIG. 2G(c), and this signal may be received through the fifth electrode 242. For example, the pen may be positioned closer to the fifth electrode 242 than to the fourth electrode 241, and thus, the second waveform 392 may be rendered to have a larger amplitude than the first waveform 391. The receiving circuit 223 may transfer the receive signal i5c to the control circuit 224. The control circuit 224 may utilize the receive signal i5c to measure the position of the pen. Meanwhile, although the receive signal i5c is shown to be an electric current, this is merely an example. It will readily be appreciated by one of ordinary skill in the art that the receive signal i5c may be implemented to be an electric current or voltage.

As shown in FIG. 2F, the conductive tip of the pen, together with a sixth electrode 243, may form a capacitance C5d. When the driving electrode 231 generates the electric field E5a by the driving signal 363, the resonance circuit 261 or 262 of the pen may generate a resonance 383. The pen resonance signal may be a receive signal i5d having a third waveform 393 of FIG. 2G(c), and this signal may be received through the sixth electrode 243. For example, the pen may be positioned closer to the sixth electrode 243 than to the fifth electrode 242, and thus, the third waveform 393 may be rendered to have a smaller amplitude than the second waveform. Fourth and fifth waveforms 394 and 395 are also illustrated. Meanwhile, FIG. 2G may be one for the cases where four or more electrodes are arranged. The receiving circuit 223 may transfer the receive signal i5d to the control circuit 224. The control circuit 224 may utilize the receive signal i5d to measure the position of the pen.

The control circuit 224 may determine the position of the pen using the electrical signals i5b to i5d respectively received from the fourth electrode 241 to the sixth electrode 243. For example, the control circuit 224 may determine that the electrode from which the largest current is received is the position of the pen. The control circuit 224 may apply interpolation to the position of each electrode and the magnitude of the received signal to calculate the position of the pen with a higher resolution than the interval between the electrodes. Meanwhile, although a configuration in which the control circuit 224 measures the X-axis position of the pen has been described above, it will be apparent to one of ordinary skill in the art that the configuration may also apply to the measurement of the Y-axis position.

As set forth above, according to an embodiment of the present disclosure, the touch sensing device does not include a coil(s) as in the scheme of using magnetic fields and may determine the position of a pen with electrodes for generating electric fields. Further, when the user touches with his finger, the touch sensing device may determine the position of the touch according to the variation in capacitance at the electrode. Therefore, according to an embodiment of the present disclosure, the touch sensing device may measure the position of an input by a pen and an input by a finger using a multi-electrode structure.

FIG. 2H is a concept view illustrating a method for measuring the position of an active pen according to an embodiment of the present disclosure.

Referring to FIG. 2H, an active pen 270 may include a power source 272 that includes a battery 275 and a signal generator 271. The active pen 270 has its own power source and may thus continuously emit an electric field E5e through the signal generator 271. Accordingly, the control circuit 224 is not required to generate a driving signal for energy delivery and may simply control the switch to sequentially connect each receive electrode 241, 242, or 243 to the receiving circuit 223. The control circuit 224 may measure the position of the active pen 270 according to the per-channel relative magnitude of the receive signal i5e.

As described above in connection with FIGS. 2B to 2H, procedures required to measure the position of the passive pen 260 and the active pen 270 differ from each other. Thus, the touch sensing device 100 is required to determine the type of a pen and to be driven depending on the type of the pen.

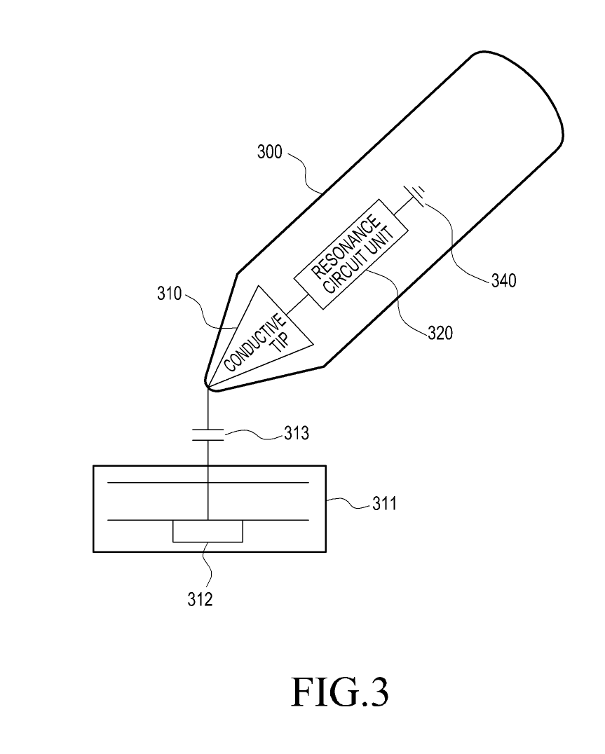

FIG. 3 is a concept view illustrating a structure of a pen according to an embodiment of the present disclosure.

Referring to FIG. 3, a pen 300 may include a conductive tip 310, a resonance circuit unit 320, and a ground unit 340. The conductive tip 310 is connected to an end of the resonance circuit unit 320. Further, the other end of the resonance circuit unit 320 may be connected to the ground unit 340.

The conductive tip 310, together with electrodes 312 included in the touch sensing device, may form a capacitance 313. The conductive tip 310 may be formed of, e.g., a metallic tip, and the conductive tip 310, along with at least one electrode 312, may form the capacitance 313. The conductive tip 310 may be present inside a non-conductive material or the whole or part of the conductive tip 310 may be exposed to the outside. Further, the at least one electrode 312 may be a transparent electrode formed of, e.g., ITO or metal mesh, under a transparent window 311, allowing it to be applied to a touchscreen.

The resonance circuit unit 320 may be resonated by a driving signal that is received from the touch sensing device. The resonance circuit unit 320 may output a resonance signal by resonance even after the input of the driving signal stops. The resonance circuit unit 320 may output, e.g., a sinusoidal signal having the resonance frequency of the resonance circuit unit 320 and whose magnitude is attenuated. According to an embodiment of the present disclosure, a signal having a particular resonance frequency may be pen identification information. In particular, when resonance energy is accumulated in the pen, although the driving signal stops occurring, the resonance may last for a predetermined time using the energy internally accumulated.

Accordingly, upon sensing a particular signal strength or higher for a signal having a particular resonance frequency after the application of the driving signal and while the driving signal stops occurring, the touch sensing device may determine that the type of the contacting object is a passive pen, thus distinguishing from contact by a finger.

Meanwhile, according to an embodiment of the present disclosure, the resonance frequency of the resonance circuit unit 320 may be varied by the pressure of contact of the conductive tip 310. For example, where the user puts a pen in contact, the inductance of an inductor or the capacitance of a capacitor in the resonance circuit unit 320 is varied, resulting in a change in the resonance frequency. Accordingly, the touch sensing device may determine the pen pressure based on the change in the resonance frequency. Further, the resonance circuit unit 320 may further include an additional capacitor connected in parallel. The additional capacitor may be connected or disconnected from the resonance circuit unit by a switch, and the resonance frequency may be varied depending on the state of the connection of the additional capacitor. Accordingly, the touch sensing device may grasp the on/off state of the switch depending on the frequency of the receive signal, and various implementations may be made based thereupon. For example, the pen may function as an eraser when the switch is pressed.

As shown in FIG. 3, a pen which does not comprise a power source inside may be denoted as a passive pen.

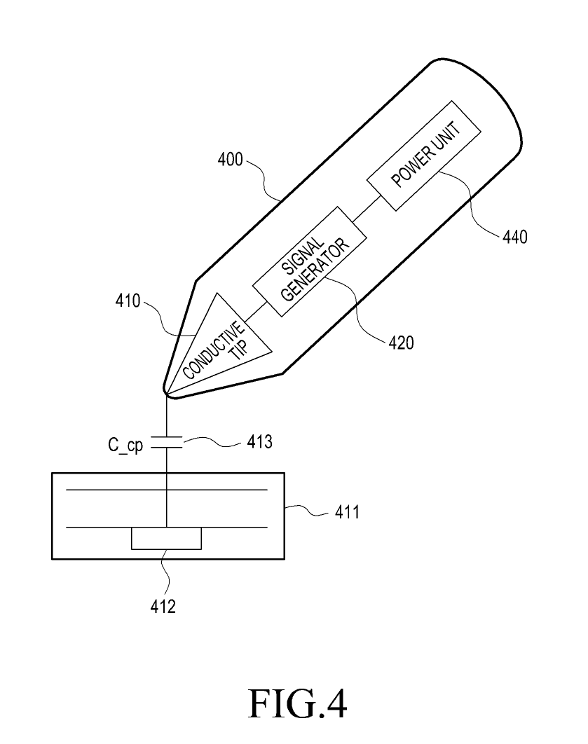

FIG. 4 is a concept view illustrating an active pen including a power source according to an embodiment of the present disclosure.

Referring to FIG. 4, an active pen 400 may include a conductive tip 410, a signal generator 420, and a power source 440. It will be apparent to one of ordinary skill in the art that no limitations are imposed on the signal generator 420 as long as the signal generator 420 is configured to be capable of generating electric signals. The signal generator 420 may generate a sinusoidal wave, a triangular wave, or a square wave using power received from the power source 440. The active pen 400 has its own power source 440 and is thus not required to receive a driving signal from the touch sensing device to receive energy for generating signals. However, the active pen 400 may receive a driving signal for triggering the generation of a signal from the touch sensing device. The conductive tip 410, together with electrode(s) 412 included in the touch sensing device, may form a capacitance 413. The electrode(s) 412 may be a transparent electrode formed of, e.g., ITO or metal mesh, under a transparent window 411, allowing it to be applied to a touchscreen.

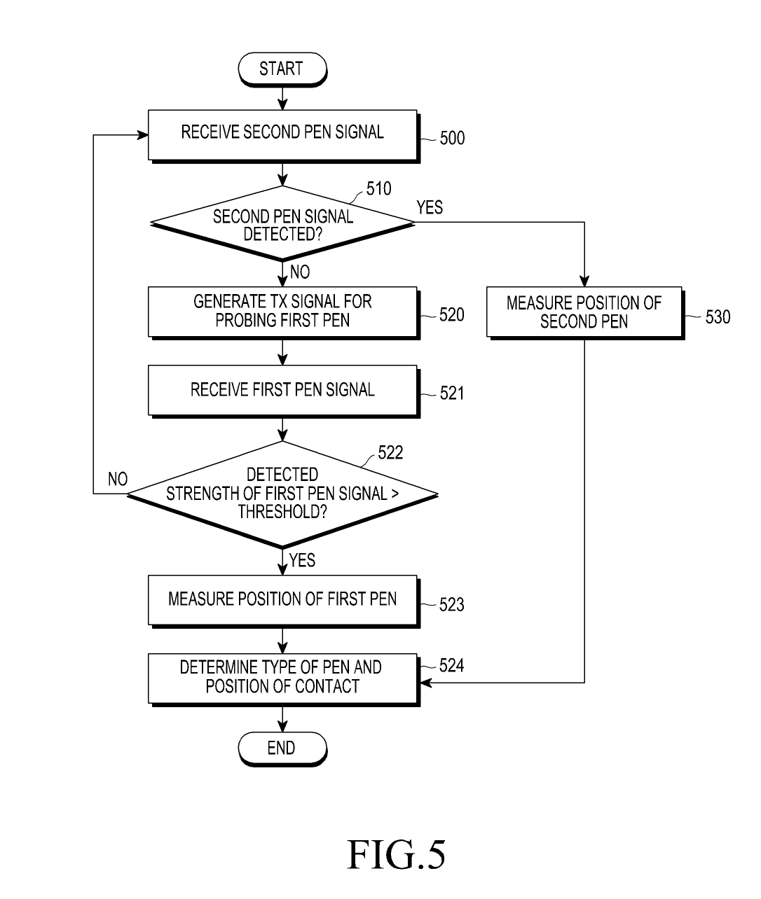

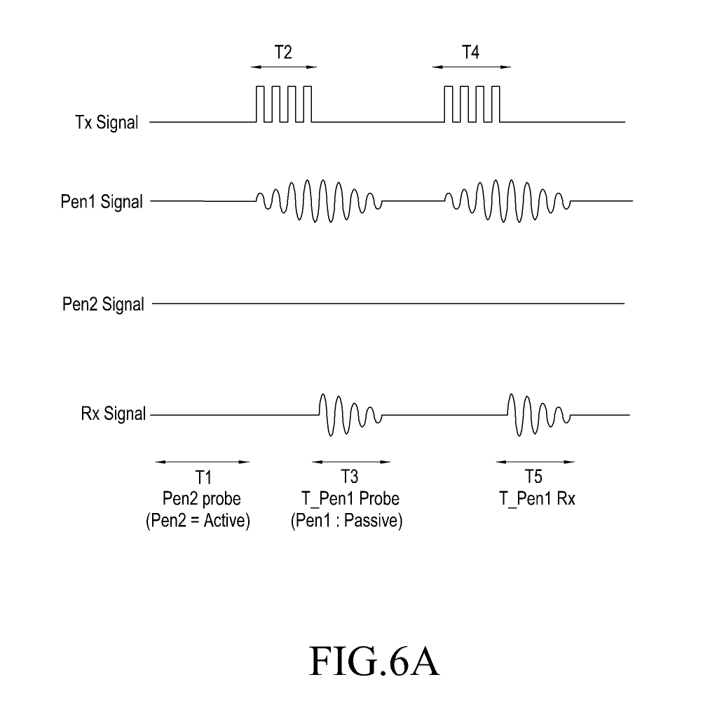

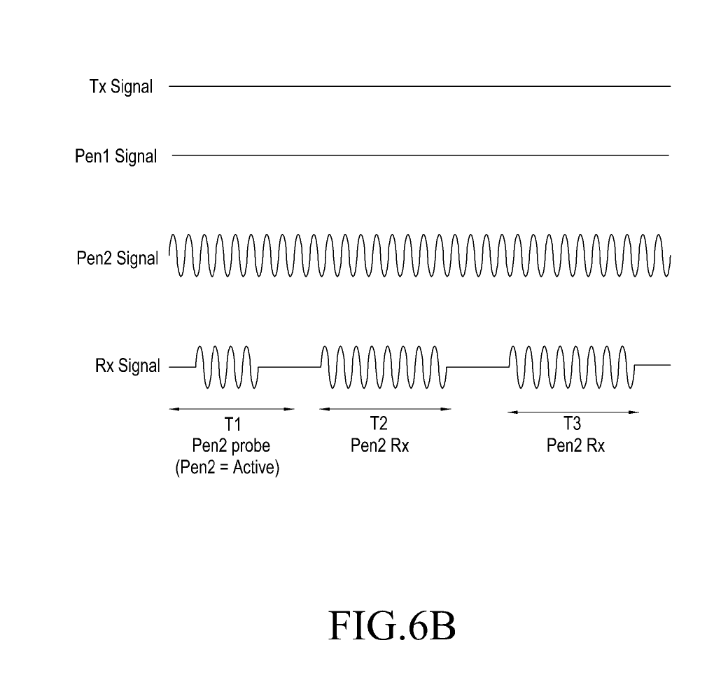

FIG. 5 is a flowchart illustrating operations of a touch sensing device according to an embodiment of the present disclosure. In the embodiment of FIG. 5, it is assumed that the second pen is an active pen, and the first pen is a passive pen. The embodiment related to FIG. 5 is described in greater detail with reference to FIGS. 6A and 6B.

FIG. 6A is a view illustrating waveforms of signals transmitted and received by a touch sensing device when an active pen is nearby according to an embodiment of the present disclosure. FIG. 6B is a view illustrating waveforms of signals transmitted and received by a touch sensing device when a passive pen is nearby according to an embodiment of the present disclosure.

Referring to FIG. 5, in operation 500, the touch sensing device 100 may attempt to receive a second pen signal. In other words, the touch sensing device 100 may perform control to connect at least one of the electrodes 111 to 116 and 121 to 126 to the receiving circuit 223. As set forth above, the active pen may generate a pen signal using its embedded power source even without receiving a driving signal from the touch sensing device 100.

Referring to FIG. 6A, the touch sensing device 100 is thus not required to generate a signal (Tx signal) that is sent to the pen to generate a pen signal. As verified from FIG. 6A, the signal (Tx signal) sent to the pen is 0. Meanwhile, a second pen signal (Pen2 Signal) may have an AC waveform that is continuously generated. The active pen may steadily generate electric signals using its power source. The amplitude of sinusoidal does not reduce because of embedded power source in the pen. Meanwhile, since no passive pen is disposed in this case, the first pen signal (Pen1 signal) may be 0. The touch sensing device 100 may perform control to connect at least one of the electrodes to the receiving circuit 223 during an active pen probing period (T1, Pen2 Probe). In operation 510, the touch sensing device 100 may determine whether the second pen signal is sensed. When an electrical signal is sensed during the active pen probing period (T1, Pen2 Probe), the touch sensing device 100 may determine that an active pen, i.e., the second pen, is positioned nearby.

When the active pen is determined to be positioned nearby, the touch sensing device 100 may measure the position of the active pen, i.e., the second pen, in operation 530. Specifically, as shown in FIG. 6A, the touch sensing device 100, upon reception of an active pen signal during the active pen probing period (T1, Pen2 Probe), may measure signals respectively outputted from the electrodes during each of receive signal measuring periods (T2, Pen2 RX, T3, Pen2 RX). For example, the touch sensing device 100 may connect the electrode of the first channel to the receiving circuit 223 to measure the strength of an electrical signal outputted from the electrode of the first channel during the receive signal measuring period (T2, Pen2 RX) and connect the electrode of the second channel to the receiving circuit 223 to measure the strength of an electrical signal outputted from the electrode of the second channel during the receive signal measuring period (T3, Pen2 RX). The time between the receive signal measuring period (T2, Pen2 RX) and the receive signal measuring period (T3, Pen2 RX) may be assigned, e.g., for switching on or off to exchange electrodes connected to the receiving circuit 223. Although it is shown in FIG. 6A that the touch sensing device 100 measures the strength of electrical signals from the pen for two channels, this is merely for illustration purposes, and the touch sensing device 100 may measure the strength of electrical signals from the pen for at least some of all of the channels. Further, the touch sensing device 100 may determine the position of the pen based on relative strengths of electrical signals received per channel According to an embodiment of the present disclosure, upon determining that the strength of a receive signal, the reception of the pen signal may be repeated for the same channel to enhance the signal to noise ratio (SN ratio), thereby leading to more accurate measurement of the position of the pen. According to an embodiment of the present disclosure, the touch sensing device 101 may determine at least one of a timing, duration, and repetition count of at least one of the transmit period of the driving signal and the receive period of the receive signal.

Referring back to FIG. 5, the touch sensing device 100 might not sense an electrical signal during the active pen probing period (T1, Pen2 Probe) (No in operation 510). For example, a passive pen, i.e., the first pen, is assumed to be positioned near the touch sensing device 100. Since the touch sensing device connects the electrode to the receiving circuit 223 alone without applying a driving signal to sense the active pen, the passive pen cannot receive a driving signal from the touch sensing device 100. As described above, the resonance circuit of the passive pen may generate a resonance using an electric signal received from the touch sensing device 100 and generate a pen signal again. Accordingly, the touch sensing device 100 is unable to receive the pen signal from the passive pen, i.e., the first pen, during the active pen probing period (T1, Pen2 Probe) during which the driving signal is not previously applied. Thus, the electrical signal (Rx signal) outputted to the receiving circuit 223 is not sensed as denoted with the T1 period of FIG. 6B.

In operation 520, the touch sensing device 100 may generate a transmit (Tx) signal for probing the first pen. For example, the touch sensing device 100 may connect at least one driving electrode of the plurality of electrodes 111 to 116 and 121 to 126 to the driving circuit 222. Accordingly, an electrical signal may be applied to the driving electrode, and the driving electrode may generate an electric signal using the applied electrical signal. For example, the touch sensing device 100 may generate a transmit (Tx) signal (Tx Signal) for probing the first pen during the T2 time period of FIG. 6B. The passive pen, i.e., the first pen, may receive the driving signal from the driving electrode and generate a resonance using the received signal. The passive pen, i.e., the first pen, may generate, e.g., a first pen signal (pent signal) of FIG. 6B. In operation 521, the touch sensing device may receive the first pen signal. For example, as shown in FIG. 6B, the touch sensing device 100 may receive a receive signal (Rx Signal) during the T3, T_Pen1 Probe period. As shown in FIG. 6B, T2, which is the period for transmitting the driving signal (Tx signal), and T2 which is the period for receiving the receive signal (Rx Signal), may be distinguished from each other. This is for preventing the driving signal from being received by the receiving circuit 223.

In operation 522, the touch sensing device may determine whether the strength of the sensed first pen signal exceeds a threshold. The threshold may be previously set to a magnitude enough to distinguish between noise and the first pen signal (pen1 signal). According to an implementation, the operation of comparing with the threshold may be omitted. Where the strength of the first pen signal is the threshold or less, the touch sensing device 100 may treat the received signal as noise and reattempt to receive the second pen signal.

When the strength of the first pen signal exceeds the threshold, the touch sensing device 100 may measure the position of the passive pen, i.e., the first pen, in operation 523. For example, the touch sensing device 100 may generate a transmit signal (Tx Signal) for measuring the position of the passive pen during the T4 period as shown in FIG. 6B. Further, the touch sensing device 100 may receive, during the T5 period, the receive signal (Rx signal) which is an electrical signal outputted as the resonance signal (Pen1 Signal) of the first pen is received by the electrode. The touch sensing device 100 may then change the electrodes for receiving the receive signal, i.e., change channels, and repeatedly perform the transmission of the driving signal (Tx signal) and the reception of the receive signal (Rx signal). The touch sensing device 100 may determine the position of the pen based on relative strengths of per-channel electrical signals. According to an embodiment of the present disclosure, upon determining that the strength of a receive signal, the transmission of the driving signal and the reception of the receive signal may be repeated for the same channel to enhance the signal to noise ratio (SN ratio), thereby leading to more accurate measurement of the position of the pen. For example, since the receive signal of the passive pen is attenuated quickly, the transmission of a 100 us transmit signal and the reception of a 100 us receive signal may be repeated eight times, so that the position of the pen may be measured for 1600 us in total. In contrast, the position of the active pen may be measured through one reception period of 400 us without such repetition because the active pen may continuously generate a predetermined magnitude of signal. In other words, different schemes for repeated measurement may be set depending on the type of a pen.

In operation 524, the touch sensing device 100 may determine the type of a pen, contact, or the position of approach. In this way, the touch sensing device 100 may determine whether the pen is an active pen or passive pen and determine the position of contact, i.e., the position of the pen.

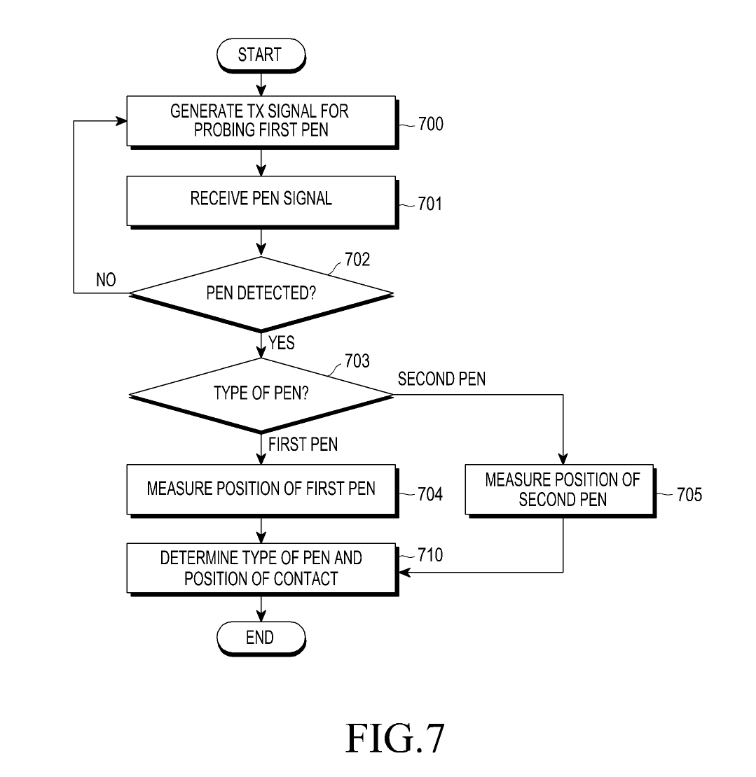

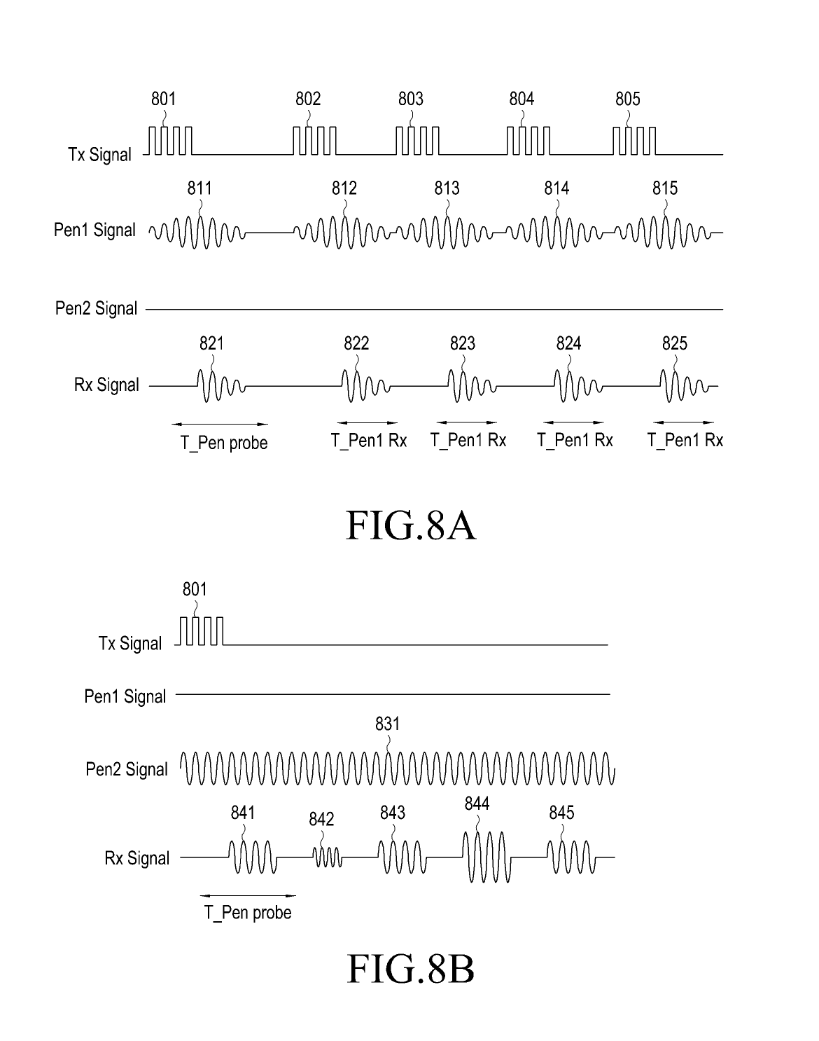

FIG. 7 is a flowchart illustrating operations of a touch sensing device according to an embodiment of the present disclosure. In the embodiment of FIG. 7, it is assumed that the second pen is an active pen, and the first pen is a passive pen. The embodiment of FIG. 7 is described in greater detail with reference to FIGS. 8A and 8B.

FIG. 8A is a view illustrating waveforms of signals transmitted and received by a touch sensing device when a passive pen is nearby according to an embodiment of the present disclosure. FIG. 8B is a view illustrating waveforms of signals transmitted and received by a touch sensing device when an active pen is nearby according to an embodiment of the present disclosure.

Referring to FIG. 7, in operation 700, the touch sensing device 100 may generate a transmit (Tx) signal for probing the first pen. For example, the touch sensing device 100 may generate a transmit signal 801 as shown in FIGS. 8A and 8B.

In operation 701, the touch sensing device 100 may connect at least one of the electrodes 111 to 116 and 121 to 126 to the receiving circuit 222, thereby attempting to receive a pen signal. In operation 702, the touch sensing device 100 may determine whether the pen signal is sensed.

When the pen signal (e.g., 821 of FIG. 8A or 841 of FIG. 8B) is sensed, the touch sensing device 100 may determine the type of the pen in operation 703. According to an embodiment of the present disclosure, the touch sensing device 100 may determine the type of the pen based on at least one of the frequency, amplitude, and waveform of an electrical signal inputted to the driving circuit 222.

For example, referring first to FIG. 8A, when a resonance is generated by the driving signal 801, the passive pen may generate a pen signal 811 according to the resonance. The touch sensing device 100 may receive a receive signal 821 generated by the pen signal 811 from each electrode. Referring to FIG. 8B, the active pen may steadily generate the pen signal 831 using its internal power source. The touch sensing device 100 may receive a receive signal 841 generated by the pen signal 831 from each electrode.

According to an embodiment of the present disclosure, the touch sensing device 100 may determine the type of pen depending on the frequency of the receive signal. For example, the pen signals respectively from the active pen and the passive pen may be set to have different frequencies. Thus, the touch sensing device 100 may determine the type of pen depending on the frequency of the receive signal. For example, the touch sensing device 100 may amplify the receive signal, analog-digital convert the same, Fourier-transform the converted digital signal into a frequency-domain signal. The touch sensing device 100 may determine the type of pen depending on frequency information of the received signal. In this case, the touch sensing device may determine a sensing frequency in a following positioning operation depending on the type of pen.

According to an embodiment of the present disclosure, the touch sensing device 100 may determine the type of pen depending on the magnitude of the receive signal. For example, the pen signal from the active pen and the pen signal from the passive pen may be set to have different magnitudes. Thus, the touch sensing device 100 may determine the type of pen depending on the magnitude of the receive signal.

According to an embodiment of the present disclosure, the touch sensing device 100 may determine the type of pen depending on the waveform of the receive signal. Specifically, since the passive pen generates a resonance and thereby generates a pen signal 811, the amplitude of the pen signal 811 can be verified to be reduced after the driving signal 801 is terminated as shown in FIG. 8A. Accordingly, since the touch sensing device 100 receives the receive signal 821 after the driving signal 801 is terminated, the amplitude of the receive signal may be in the form of being reduced. Meanwhile, in the case of the active pen, the receive signal 841 received may remain at a constant magnitude. Upon sensing a waveform whose amplitude is reduced, the touch sensing device 100 may determine that the type of the pen is a passive pen, and upon sensing a waveform whose amplitude remains constant, the touch sensing device 100 may determine that the type of the pen is an active pen. For example, the touch sensing device 100 may compare the amplitude of the receive signal at an early stage with the amplitude of the receive signal at a later stage and determine the type of the pen depending on a result of the comparison.

Upon determining that the pen is a passive pen, i.e., the first pen, the touch sensing device 100 may measure the position of the passive pen, i.e., the first pen, in operation 704. For example, the touch sensing device 100 may send driving signals 802, 803, 804, and 805 to the passive pen, and the passive pen may generate pen signals 812, 813, 814, and 815 using the resonance by the driving signals 802, 803, 804, and 805. The touch sensing device 100 may receive signals 822, 823, 824, and 825 generated by the pen signals 812, 813, 814, and 815. The receive signals 822, 823, 824, and 825 may be receive signals respectively for the channels. The touch sensing device 100 may determine the position of the pen based on relative strengths of the receive signals 822, 823, 824, and 825.

Upon determining that the pen is an active pen, i.e., the second pen, the touch sensing device 100 may be operated to measure the position of the active pen, i.e., the second pen, in operation 705. The touch sensing device 100 may receive signals 842, 843, 844, and 845 from the active pen. The receive signals 824, 843, 844, and 845, respectively, may be per-channel receive signals. The touch sensing device 100 may determine the position of the pen based on relative strengths of the receive signals 842, 843, 844, and 845.

In operation 710, the touch sensing device 100 may determine the type of a pen, contact, or the position of approach.

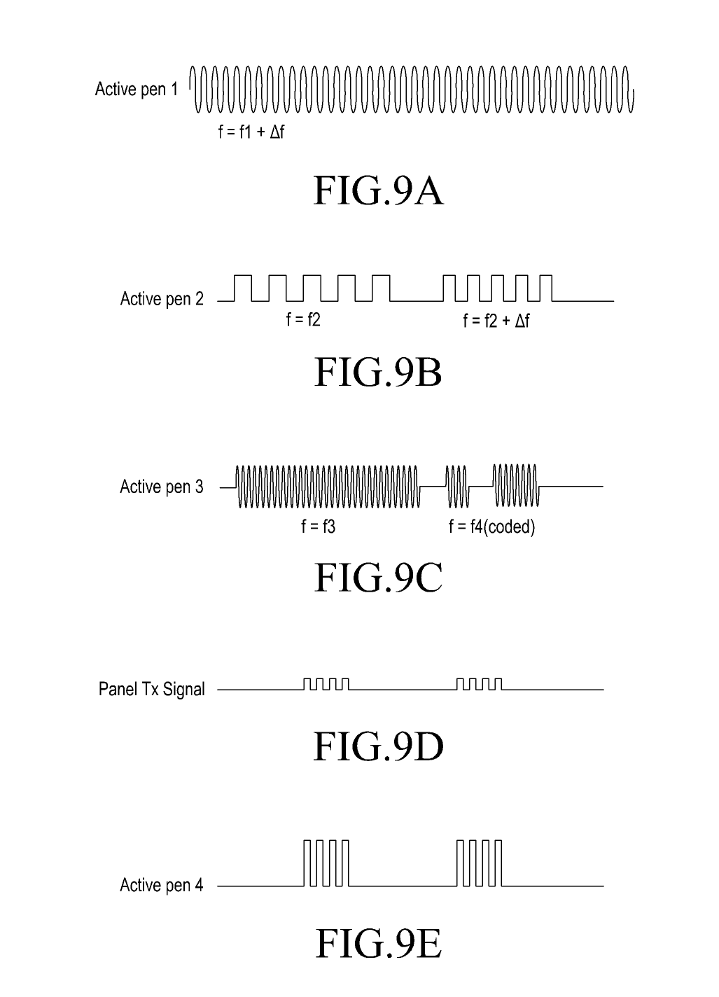

FIGS. 9A, 9B, 9C, 9D, and 9E are views illustrating waveforms by various active pens according to various embodiments of the present disclosure.

The basic structure of various active pens shown in FIGS. 9A to 9E may be the same as that shown in FIG. 4. However, where the active pen needs to receive a signal from the touch sensing device, a signal receiver may be further included in addition to the signal generator 420.

The touch sensing device 100 may use a receive signal received from the active pen for two purposes. The touch sensing device 100 may determine the position of contact or approach of the pen using the receive signal. The touch sensing device 100 may also use the receive signal to determine additional information, such as a pen pressure, whether a button is contacted, or the unique number of the pen, transmitted from the pen.

Referring to FIG. 9A, a first active pen (Active pen 1) may basically generate an AC waveform of signal with a frequency f1. The first active pen may change (Δf) the frequency of a signal generated according to the pen pressure. Accordingly, the touch sensing device 100 may measure the pen pressure according to the frequency of the received signal. Further, different frequencies may be set to be generated from the pen depending on, e.g., the pressing of a button in the pen, as well as the pen pressure. Accordingly, the touch sensing device 100 may determine whether the button in the pen is pressed according to the frequency of the received signal. Change of frequency corresponding to a pen button pressing may be differently set from the change of frequency corresponding to pen tip pressing.

Referring to FIG. 9B, a second active pen (Active pen 2) may generate a signal of frequency f2 during a first period and a signal of a frequency that has been shifted by Δf from f2 during a second period. The frequency shift (Δf) in the second period may be attributed to the pen pressure. The touch sensing device 100 may determine the position of the pen from the magnitude of the signal in the first period, which is received through each channel, and the magnitude of the signals received in the first period and the second period. The touch sensing device 100 may measure the pen pressure according to the frequency shift (Δf).

Referring to FIG. 9C, a third active pen (Active pen 3) may generate a signal of frequency f3 during the first period and a signal of frequency f4 during the second period. Here, the f3 signal may be one for measuring the position of the pen, and the f4 signal may be one for measuring the pen pressure or whether the button is pressed. The third active pen does not reflect the pen pressure information to the signal frequency, and the third active pen converts the information into a digital code, pulse-amplitude-modulates (PAM) the signal of frequency f4, and provides a resultant signal. Here, frequency f4 may be the same as frequency f3. The third active pen may further include a pen pressure sensing circuit.

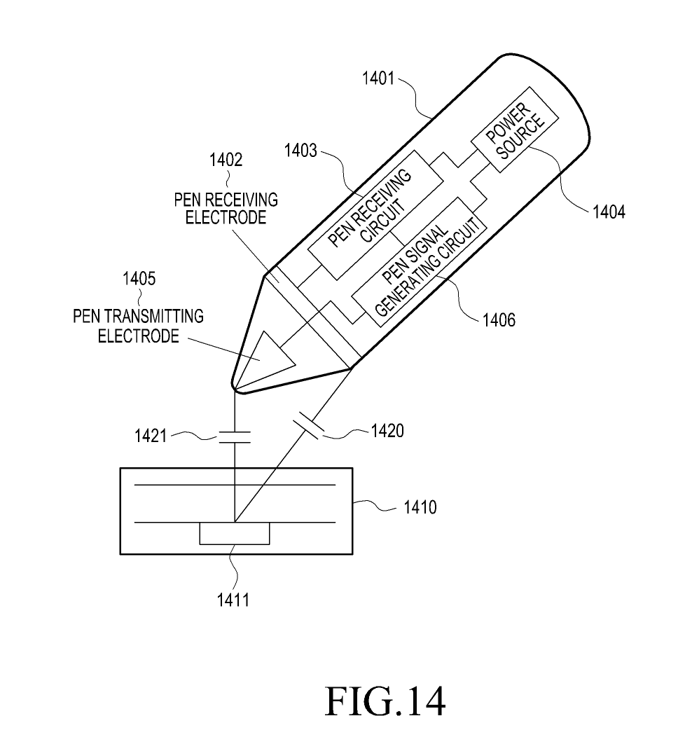

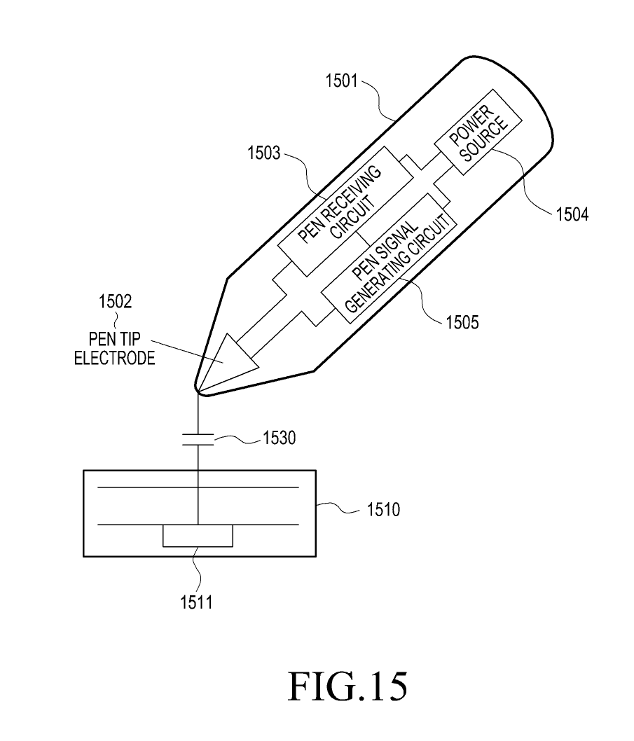

Referring to FIGS. 9D and 9E, a fourth active pen (Active pen 4) may amplify or modulate a driving signal (panel Tx signal) from the panel of the touch sensing device, thereby generating a signal. This is described below in greater detail with reference to FIGS. 14 and 15.

Whichever of the first active pen to the fourth active pen is positioned, the touch sensing device 100 may determine the type of pen based on frequency information that it has previously grasped.

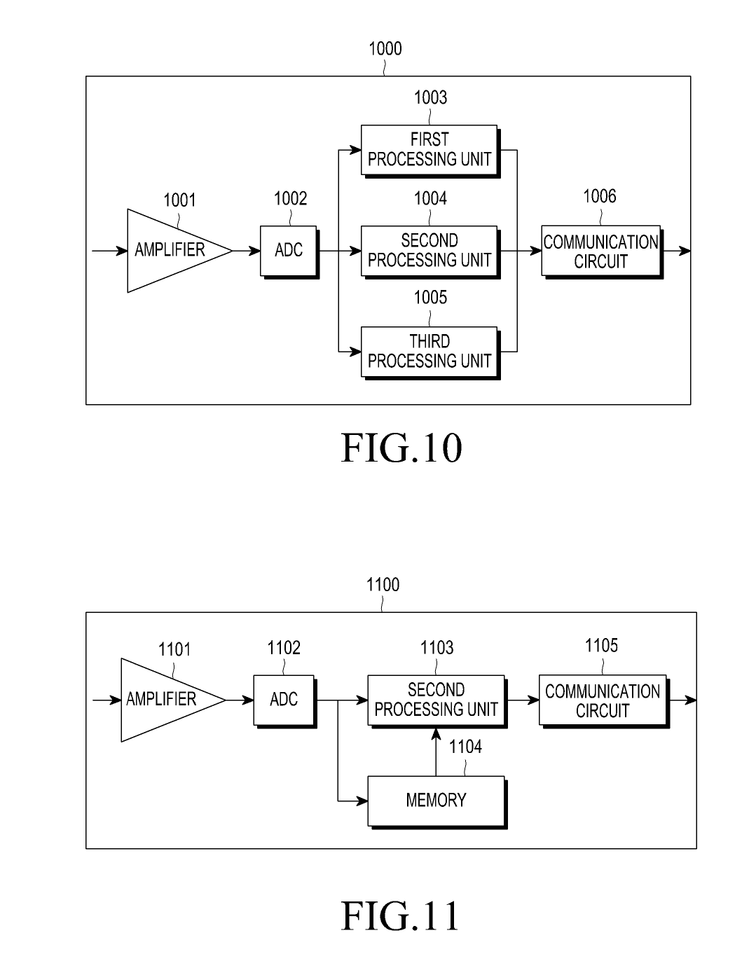

FIG. 10 is a block diagram illustrating a receiving circuit 1000 according to an embodiment of the present disclosure.

Referring to FIG. 10, the receiving circuit 1000 may sequentially receive signals per channel from a pen. Where a plurality of channel electrodes is simultaneously connected, a plurality of receiving circuits 1000 having the structure shown in FIG. 10 may be provided in the touch sensing device 100.

An amplifier 1001 may amplify the electrical signal from the electrode. An analog-to-digital converter (ADC) 1002 may convert the amplified signal into a digital signal.

The converted signal may be transferred to a plurality of processing units (PU1, PU2, and PU3) 1003, 1004, and 1005. Each of the processing units 1003, 1004, and 1005 (e.g., processors) may perform a process for sensing the first active pen, the second active pen, and the third active pen as shown in FIGS. 9A to 9E. When the process is complete, the processing units 1003, 1004, and 1005 each may deliver a result of the process to a communication circuit 1006. The result of the process may include the magnitude of the signal from the electrode and the type of the pen. The communication circuit 1006 may output the result of the process to the control circuit 224. The communication circuit 1006 (e.g., transceiver) may be a circuit for data transmission and wiredly or wirelessly output the result of the process to the control circuit 224.

The receiving circuit 1000 may also receive ambient noise from, e.g., the display panel, as well as the signal generated from the pen. The noise introduced from the channel electrode is amplified by the amplifier 1001 in the same ratio as the pen signal. The noise introduced from an ambient noise source needs to be removed to more accurately measure the magnitude of the signal generated from the pen. There may be various methods for removing noise. Where the operation frequency of the pen is known, the noise from an ambient noise source may effectively be removed through, e.g., Fourier transform. There may be various Fourier transform schemes, an example of which may be to obtain the inner produce of a sinusoidal signal of a particular frequency and a receive signal. In the instant embodiment, where the operation frequencies of the first to third active pens are similar to one another, the signal processing of the first to third active pens may be carried out by a processing unit capable of processing signals of one frequency bands. However, where different frequency bands of signals are processed, parallel signal processing may be conducted by processing units suited for the frequency bands, respectively. By doing so, signal processing for multiple pens may be performed simultaneously and quickly.

In this case, each processing unit may include a circuit for processing the sinusoidal signal of the frequency band of which it is in charge. In other words, the signal of the frequency band corresponding to the first active pen may be processed by the processing unit 1003, the signal of the frequency band corresponding to the second active pen may be processed by the processing unit 1004, and the signal of the frequency band corresponding to the third active pen may be processed by the processing unit 1005.

Where the second active pen contacts the touch sensing device, the processing unit 1003 and the processing unit 1005 cannot sense signals, and the processing unit 1004 can sense a signal and transmits the magnitude of the sensed signal through the communication circuit 1006 to the control circuit 224. The control circuit 224 may determine which processing unit has sensed the signal. Thus, the control circuit 224 may determine that the second active pen is in contact or positioned nearby.

FIG. 11 illustrates another embodiment of the present disclosure. A method for sensing various types of active pens with a plurality of processing units has been described above in connection with the foregoing embodiments. Such method, however, has a shortcoming that the circuit unit 1220 might be bulky because it needs the respective processing units for the various types of active pens.

FIG. 11 is a block diagram illustrating a receiving circuit 1100 according to an embodiment of the present disclosure.

Referring to FIG. 11, a memory 1104 may be further included. The memory 1104 may store the waveforms of receive signals that have been amplified by the amplifier 1101 and converted by the analog-to-digital converter (ADC) 1102. The processing unit 1103 may perform signal processing on the first active pen while a first signal is received. Unless the first active pen is sensed, the processing unit 1103 may perform signal processing on the second active pen using the waveform stored in the memory 1104. Unless the second active pen is sensed, the processing unit 1103 may perform signal processing on the third active pen using the waveform stored in the memory 1104. In other words, the processing unit 1103 may sequentially determine whether different types of pens are sensed. A result of the process may be delivered through the communication circuit 1105 (e.g., transceiver) to the control circuit 224. By doing so, the number of processing units may be reduced.

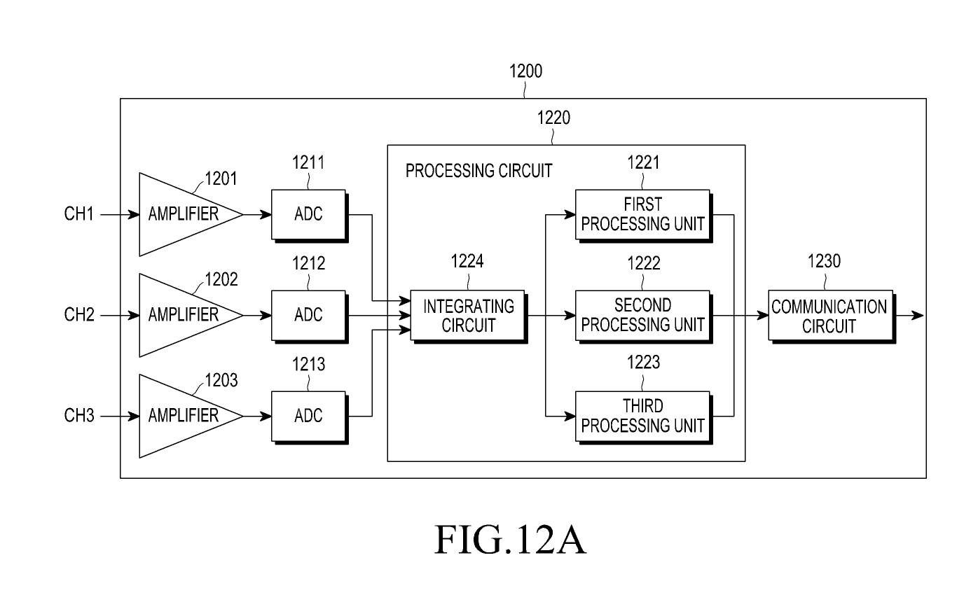

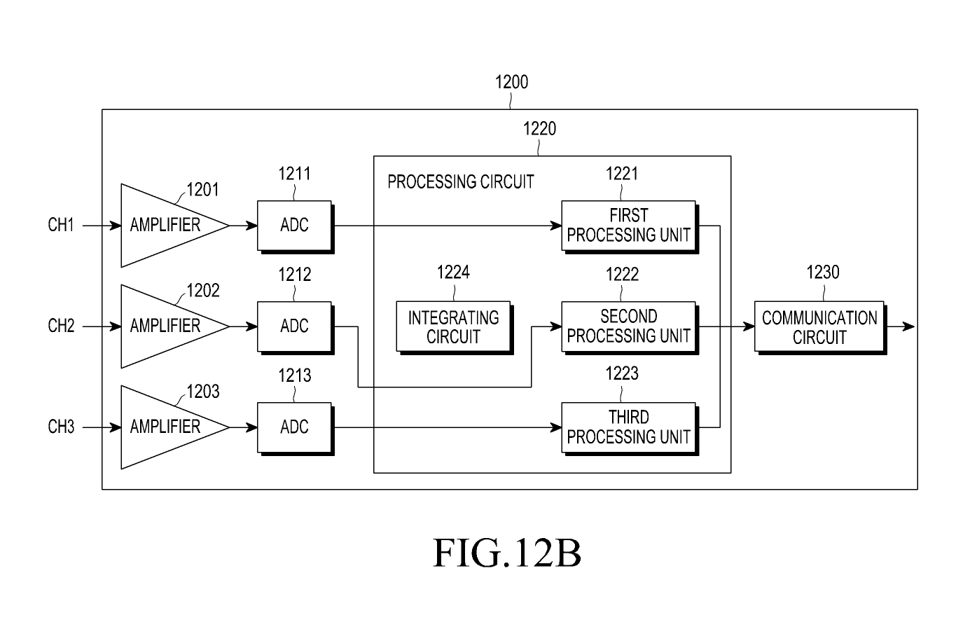

FIGS. 12A and 12B are block diagrams illustrating receiving circuits according to embodiments of the present disclosure.

Referring to FIG. 12A, a receiving circuit 1200 may include amplifiers 1201, 1202, and 1203 that are respectively connected with a first channel (CH1) electrode, a second channel (CH2) electrode, and a third channel (CH3) electrode. ADCs 1211, 1211, and 1213, respectively, may be connected with the amplifiers 1201, 1202, and 1203. Meanwhile, an integrating circuit 1224 may be connected to the ADCs 1211, 1212, and 1213. The integrating circuit 1224 may summate electrical signals from the first channel CH1 to the third channel CH3.

The integrating circuit 1224 may deliver the result of the summation to each of the first processing unit 1221, the second processing unit 1222, and the third processing unit 1223. The first processing unit 1221 may perform signal processing on the first active pen, the second processing unit 1222 may perform signal processing on the second active pen, and the third processing unit 1223 may perform signal processing on the third active pen. The communication circuit 1230 may deliver the result of processing to the control circuit 224. The control circuit 224 may determine the type of the pen depending on which processing unit it receives the result of processing from.

Meanwhile, the receiving circuit 1200 may also be applied to a fourth channel, a fifth channel, and a sixth channel, which are not shown, and the approximate position of contact of the pen may be known by repeating such process. In other words, it can be known whether the pen is positioned at the first channel to the third channel or at the fourth channel to the sixth channel Such process may be referred to as global scan.

Referring to FIG. 12B, the touch sensing device 100 may more precisely determine the position of a pen. When detecting the position of the pen, digital signals may be transferred to the processing units 1221, 1222, and 1223, respectively, without passing through the integrating circuit 1224. The touch sensing device 100 may choose channels for exactly determining the position of the pen based on the result of the global scan. In this case, the processing units 1221, 1222, and 1223 may be operated to process a signal corresponding to the pen determined by them all to have been brought into contact. For example, where the first active pen is chosen as the type of pen, the processing units 1221, 1222, and 1223 all may be operated to process the first active pen. The control circuit 224 may determine the position of the pen according to relative strengths of per-channel signals, which may be denoted as local scan.

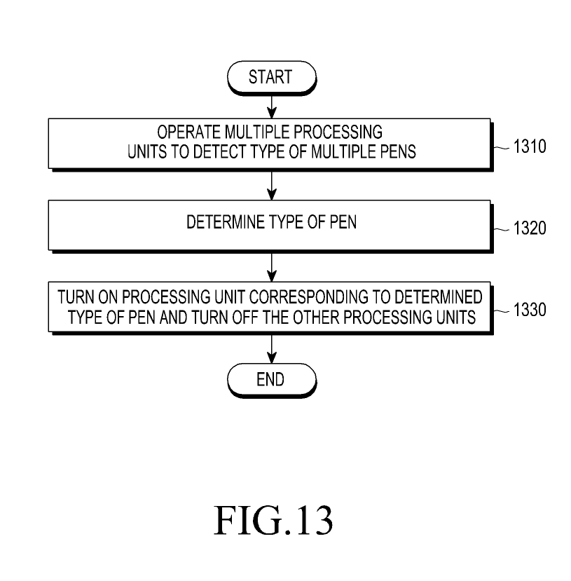

FIG. 13 is a flowchart illustrating operations of a touch sensing device according to an embodiment of the present disclosure.

Referring to FIG. 13, in operation 1310, the touch sensing device 100 may operate a plurality of processing units for detecting the type of a plurality of pens. For example, the touch sensing device 100 may operate each of the first processing unit 1003 to the third processing unit 1005 as shown in FIG. 10. In operation 1320, the touch sensing device 100 may detect the type of the pen. As set forth above in connection with FIG. 10, the touch sensing device 100 may detect the type of the pen depending on which processing unit the result of process is detected from.

In operation 1330, the touch sensing device 100 may turn on the processing unit corresponding to the determined type of pen while turning off the remaining processing units. For example, where the touch sensing device 100 determines that the type of the pen is the second active pen, the touch sensing device 100 may turn on the second processing unit 1004 which is capable of processing the second active pen while turning off the first processing unit 1003 and the third processing unit 1005. Accordingly, where the user exchanges multiple pens, such a situation may be avoided where a pen other than the pen currently in use is brought and sensed within the area of contact of the pen currently in use although not intended by the user to slow down the touch sensing device.

FIG. 14 is a concept view illustrating a pen according to an embodiment of the present disclosure.

When one pen may work on multiple touch sensing devices operated in various manners, the user may sequentially use the pen on the multiple touchscreen devices in which case more convenience may be achieved.

Referring to FIG. 14, a pen receiving circuit 1403 of a pen 1401 receives a signal generated by a touch sensing device 1410 through a capacitance 1420 and/or 1421 formed between a channel electrode 1411 of the touch sensing device 1410 and the pen receiving electrode 1402.

The pen 1401 may determine the type of the touch sensing device that is operated according to the signal from the touch sensing device 1410 and generate a signal corresponding thereto through a pen signal generating circuit 1406. The generated pen signal is delivered back to the channel electrode 1411 through a capacitive coupling between a pen transmitting electrode 1405 and the channel electrode 1411, and the touch sensing device 1410 may determine the position of the pen based on the delivered pen signal. According to an embodiment of the present disclosure, the pen 1401 may determine the type of the touch sensing device 1410 based on at least one of the amplitude, waveform, and frequency of a signal generated from the touch sensing device 1410. As set forth above, a universal pen may be provided which may be applied to any type of panel. The pen signal generating circuit 1406 may generate a pen signal corresponding to the type of the touch sensing device 1410 using power from a power source 1404. The pen transmitting electrode 1405 may generate a pen signal based on a signal provided from the pen signal generating circuit 1406, and the pen signal may be transferred to a channel electrode 1411 of the touch sensing device 1410 through the capacitive coupling 1421.

FIG. 15 is a concept view illustrating a pen according to an embodiment of the present disclosure.

Referring to FIG. 15, a pen 1501 may receive a signal generated by a touch sensing device 1510 through a pen tip electrode 1502 and may transfer a signal from the pen 1501. The reception and transmission of a signal may simultaneously be performed. Alternatively, a time division method may be used so that a pen signal is received during a predetermined period, and a pen signal is generated during a predetermined period.

Since the repetition of the pen reception may deteriorate the operational efficiency of the pen, the touch sensing device 1510 has a low chance of being varied while the touch sensing device is sensed and note taking is performed or within a predetermined time (e.g., 50 msec) from the period when a pen pressure is applied. Thus, the receiving period for sensing the type of the touch sensing device 1510 may be omitted.

In this way, the power consumption of the pen may be minimized while the driving of the pen may speed up. In order to perform such operations, a circuit may be added to sense the pressure of contact of the pen tip. Meanwhile, a pen receiving circuit 1503 may abstain from receiving or processing an electrical signal for determining the type of the touch sensing device during a preset period after the pen pressure is sensed by the pen pressure sensing circuit.

A signal from an electrode 1511 of the touch sensing device 1510 may be transferred through a capacitive coupling 1530 to a pen tip electrode 1502. The pen receiving circuit 1503 may receive a signal from the touch sensing device, sense the type of the touch sensing device 1510 based on at least one of the frequency, amplitude, and waveform of the signal from the touch sensing device, and transfer the sensed information to a pen signal generating circuit 1505. The pen signal generating circuit 1505 may generate a pen signal corresponding to the transferred information using power from a power source 1504. The pen tip electrode 1502 may receive the pen signal from the pen signal generating circuit 1505 to generate a pen signal, and the generated pen signal may be transferred to an electrode 1511 of the touch sensing device 1510 through the capacitive coupling 1530.

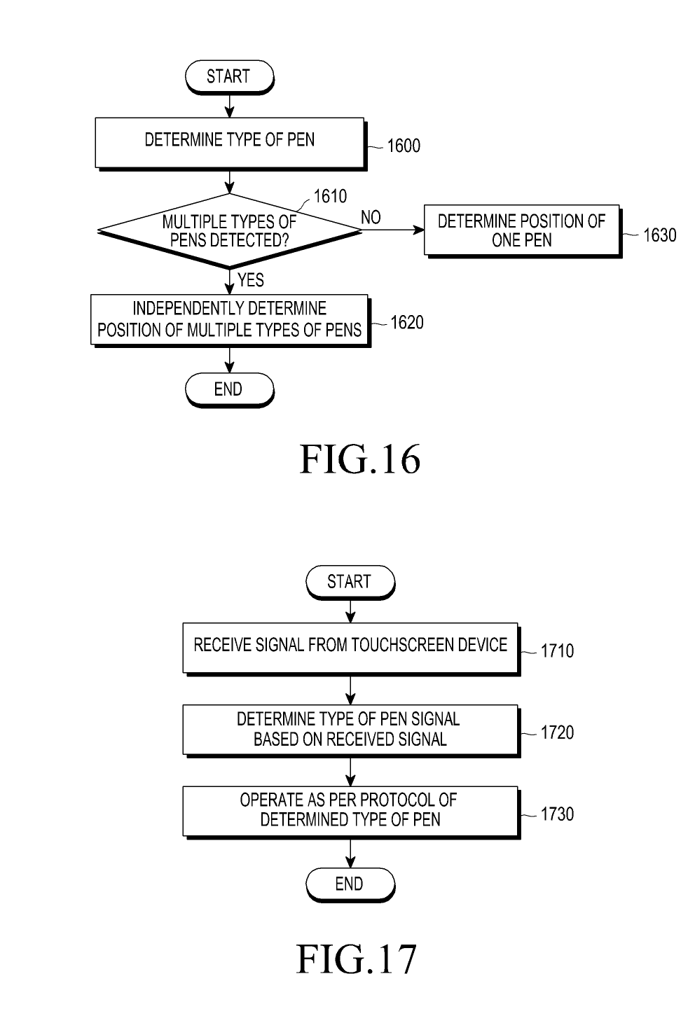

FIG. 16 is a flowchart illustrating operations of a touch sensing device according to an embodiment of the present disclosure.

Referring to FIG. 16, in operation 1600, the touch sensing device 100 may detect the type of the sensed pen. In operation 1610, the touch sensing device 100 may determine whether multiple types of pens are detected. For example, the touch sensing device 100 may detect the multiple types of pens according to the detection of multiple frequencies of pen signals. When one type of pen is detected, the touch sensing device 100 may determine the pen of the pen in operation 1630.

In operation 1620, when multiple types of pens are detected, the touch sensing device 100 may independently determine the position of the multiple types of pens. For example, the touch sensing device 100 may detect a first active pen and a second active pen. The touch sensing device 100 may determine the position of the first active pen, and the touch sensing device 100 may determine the position of the second active pen independently from the position of the first active pen. Accordingly, the multiple different types of pens may be used by one touch sensing device. For example, there may be a situation in which different types of pens may be used simultaneously. A critical function for large-scale electronic boards is to allow for simultaneous use by several people. Where two users, A and B, take notes with different types of pens, the touch trajectory of A's pen and the touch trajectory of B's pen need to clearly be separated so that the two users, A and B, may independently do the note taking.

For example, according to an embodiment of the present disclosure, the touch sensing device 100 may be operated in a scheme appropriate for a first active pen in a panel area corresponding to the position of the first active pen and in a scheme appropriate for a second active pen in a panel area corresponding to the position of the second active pen.

Meanwhile, depending on whether a first type of pen is sensed, the touch sensing device 100 may set a different electrode area for sensing a second type of pen, according to an embodiment of the present disclosure. For example, unless the first type of pen is sensed, the touch sensing device 100 may set the overall electrode area as the area for sensing the second type of pen. Meanwhile, when the first type of pen is sensed, the touch sensing device 100 may set part of the area, rather than the overall area, as the area for sensing the second type of pen.

FIG. 17 is a flowchart illustrating a method for operating a pen according to an embodiment of the present disclosure.

Referring to FIG. 17, in operation 1710, a pen may receive a signal from a touch sensing device. In operation 1720, the pen may determine the type of the touch sensing device based on the signal received from the touchscreen device and accordingly determine the type of a pen signal to be generated. In operation 1730, the pen may be operated according to protocol corresponding to the determined type. For example, the pen may transmit a pen signal at least one of the pattern and frequency of which has been set to be different depending on protocol corresponding to the determined type.

Alternatively, the touchscreen device may vary the pattern of a signal transmitted to the pen, the pattern of the receiving period during which the signal is received from the pen or a method for measuring the pressure of contact of the pen according to the user's choice.

Meanwhile, according to an embodiment of the present disclosure, the pen may select a protocol and operate according to the user's input. The pen may further include a control circuit that varies the sensing frequency according to the user's choice.

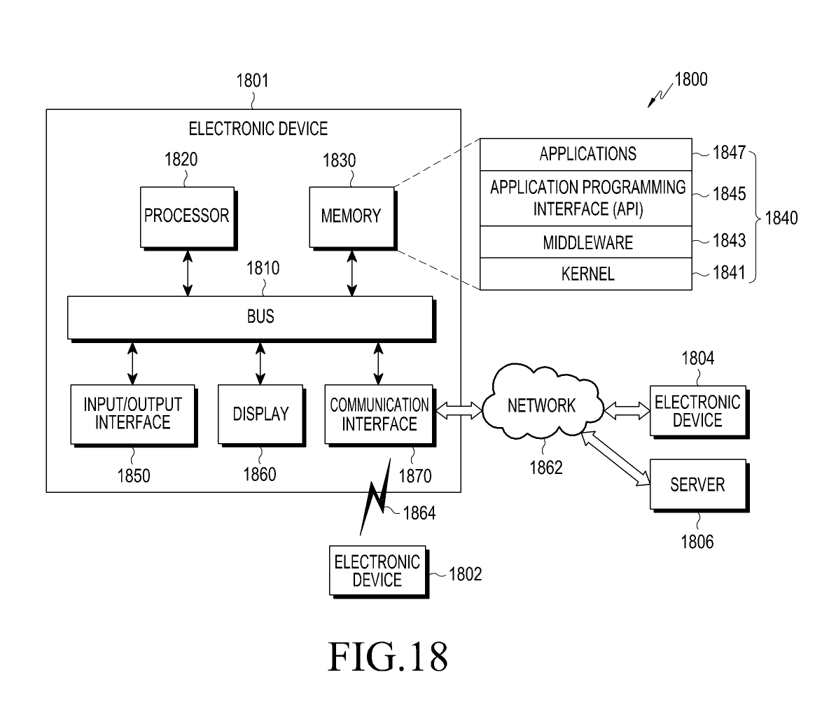

Referring to FIG. 18, according to an embodiment of the present disclosure, there is provided a touch sensing device 1801 in a network environment 1800. The touch sensing device 1801 may include a bus 1810, a processor 1820, a memory 1830, an input/output interface 1850, a display 1860, and a communication interface 1870. In some embodiments, the touch sensing device 1801 may exclude at least one of the components or may add another component. The bus 1810 may include a circuit for connecting the components 1810 to 1870 with one another and transferring communications (e.g., control messages or data) between the components. The processor 1820 (e.g., processing module) may include one or more of a central processing unit (CPU), an application processor (AP), or a communication processor (CP). The processor 1820 may perform control on at least one of the other components of the touch sensing device 1801, and/or perform an operation or data processing relating to communication.

The memory 1830 may include a volatile and/or non-volatile memory. For example, the memory 1830 may store commands or data related to at least one other component of the touch sensing device 1801. According to an embodiment of the present disclosure, the memory 1830 may store software and/or a program 1840. The program 1840 may include, e.g., a kernel 1841, middleware 1843, an application programming interface (API) 1845, and/or an application program (or “application”) 1847. At least a portion of the kernel 1841, middleware 1843, or API 1845 may be denoted an operating system (OS). For example, the kernel 1841 may control or manage system resources (e.g., the bus 1810, processor 1820, or a memory 1830) used to perform operations or functions implemented in other programs (e.g., the middleware 1843, API 1845, or application program 1847). The kernel 1841 may provide an interface that allows the middleware 1843, the API 1845, or the application program 1847 to access the individual components of the touch sensing device 1801 to control or manage the system resources.

The middleware 1843 may function as a relay to allow the API 1845 or the application program 1847 to communicate data with the kernel 1841, for example. Further, the middleware 1843 may process one or more task requests received from the application program 1847 in order of priority. For example, the middleware 1843 may assign a priority of using system resources (e.g., bus 1810, processor 1820, or memory 1830) of the touch sensing device 1801 to at least one of the application programs 1847 and process one or more task requests. The API 1845 is an interface allowing the application 1847 to control functions provided from the kernel 1841 or the middleware 1843. For example, the API 133 may include at least one interface or function (e.g., a command) for filing control, window control, image processing or text control. For example, the input/output interface 1850 may transfer commands or data input from the user or other external device to other component(s) of the touch sensing device 1801 or may output commands or data received from other component(s) of the touch sensing device 1801 to the user or other external devices.

The display 1860 may include, e.g., a liquid crystal display (LCD), a light emitting diode (LED) display, an organic light emitting diode (OLED) display, or a microelectromechanical systems (MEMS) display, or an electronic paper display. The display 1860 may display, e.g., various contents (e.g., text, images, videos, icons, or symbols) to the user. The display 1860 may include a touchscreen and may receive, e.g., a touch, gesture, proximity or hovering input using an electronic pen or a body portion of the user. For example, the communication interface 1870 may set up communication between, e.g., the touch sensing device 1801 and an external device (e.g., a first external touch sensing device 1802, a second external touch sensing device 1804, or a server 1806). For example, the communication interface 1870 may be connected with a network 1862 through wireless communication or wired communication and may communicate with an external device (e.g., the second external touch sensing device 1804 or server 1806).

The wireless communication may include cellular communication which uses at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM). According to an embodiment of the present disclosure, the wireless communication may include at least one of, e.g., Wi-Fi, Bluetooth (BT), Bluetooth low power (BLE), Zigbee, near field communication (NFC), magnetic secure transmission (MST), radio frequency, or body area network (BAN). According to an embodiment of the present disclosure, the wireless communication may include global navigation satellite system (GNSS). The GNSS may be, e.g., global positioning system (GPS), global navigation satellite system (Glonass), Beidou navigation satellite system (hereinafter, “Beidou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 1862 may include at least one of telecommunication networks, e.g., a computer network (e.g., local area network (LAN) or wide area network (WAN)), Internet, or a telephone network.

The first and second touch sensing devices 1802 and 1804 each may be a device of the same or a different type from the touch sensing device 1801. According to an embodiment of the present disclosure, all or some of operations executed on the touch sensing device 1801 may be executed on another or multiple other touch sensing devices (e.g., the touch sensing devices 1802 and 1804 or server 1806). According to an embodiment of the present disclosure, when the touch sensing device 1801 should perform some function or service automatically or at a request, the touch sensing device 1801, instead of executing the function or service on its own or additionally, may request another device (e.g., the touch sensing devices 1802 and 1804 or server 1806) to perform at least some functions associated therewith. The other touch sensing devices (e.g., the touch sensing devices 1802 and 1804 or server 1806) may execute the requested functions or additional functions and transfer a result of the execution to the touch sensing device 1801. The touch sensing device 1801 may provide a requested function or service by processing the received result as it is or additionally. To that end, a cloud computing, distributed computing, or client-server computing technique may be used, for example.

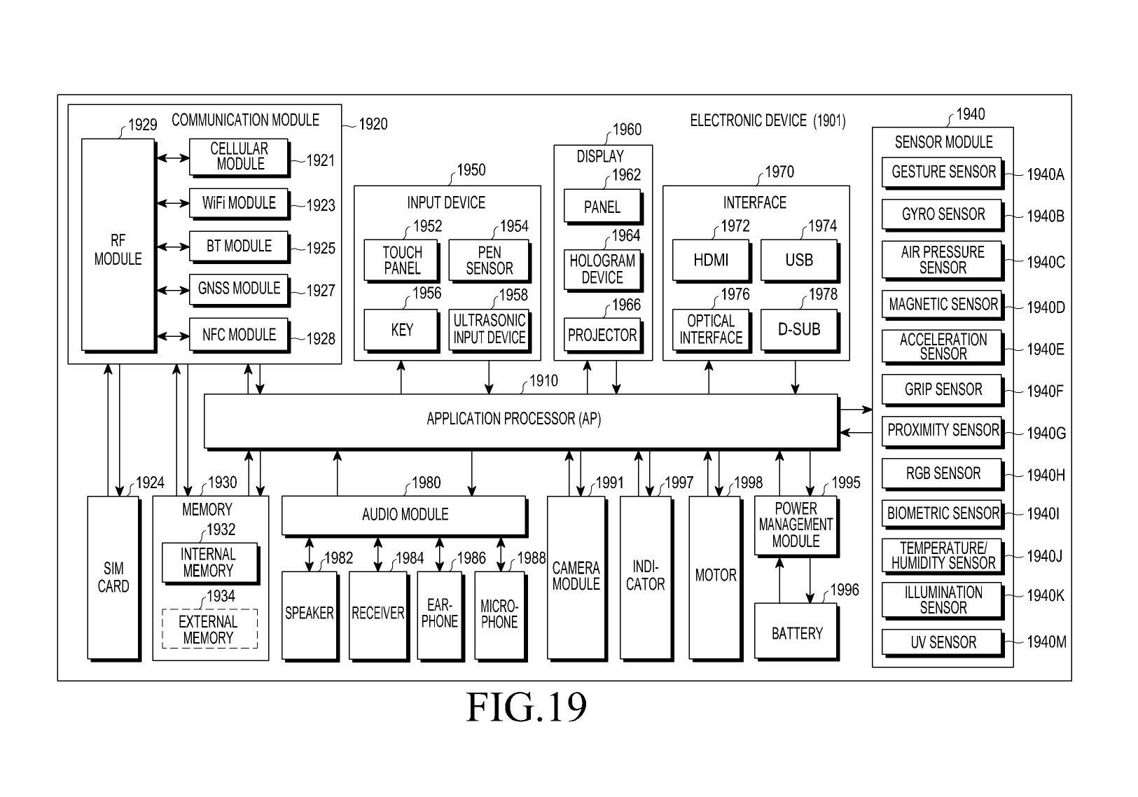

FIG. 19 is a block diagram illustrating a touch sensing device 1901 according to an embodiment of the present disclosure.

Referring to FIG. 19, the touch sensing device 1901 may include the whole or part of the configuration of, e.g., the touch sensing device 1801 shown in FIG. 18. The touch sensing device 1901 may include one or more processors (e.g., application processors (APs)) 1910, a communication module 1920, a subscriber identification module (SIM) 1924, a memory 1930, a sensor module 1940, an input device 1950, a display 1960, an interface 1970, an audio module 1980, a camera module 1991, a power management module 1995, a battery 1996, an indicator 1997, and a motor 1998. The processor 1910 may control multiple hardware and software components connected to the processor 1910 by running, e.g., an operating system or application programs, and the processor 1910 may process and compute various data. The processor 1910 may be implemented in, e.g., a system on chip (SoC). According to an embodiment of the present disclosure, the processor 1910 may further include a graphic processing unit (GPU) and/or an image signal processor (ISP). The processor 1910 may include at least some (e.g., the cellular module 1921) of the components shown in FIG. 19. The processor 1910 may load a command or data received from at least one of other components (e.g., a non-volatile memory) on a volatile memory, process the command or data, and store resultant data in the non-volatile memory.

The communication module 1920 may have the same or similar configuration to the communication interface 1870. The communication module 1920 may include, e.g., a cellular module 1921, Wi-Fi module 1923, a BT module 1925, a GNSS module 1927, a NFC module 1928, and a RF module 1929. The cellular module 1921 may provide voice call, video call, text, or Internet services through, e.g., a communication network. The cellular module 1921 may perform identification or authentication on the touch sensing device 1901 in the communication network using a subscriber identification module (SIM) 1924 (e.g., the SIM card). According to an embodiment of the present disclosure, the cellular module 1921 may perform at least some of the functions providable by the processor 1910. According to an embodiment of the present disclosure, the cellular module 1921 may include a communication processor (CP). According to an embodiment of the present disclosure, at least some (e.g., two or more) of the cellular module 1921, the Wi-Fi module 1923, the BT module 1925, the GNSS module 1927, or the NFC module 1928 may be included in a single integrated circuit (IC) or an IC package. The RF module 1929 may communicate data, e.g., communication signals (e.g., RF signals). The RF module 1929 may include, e.g., a transceiver, a power amp module (PAM), a frequency filter, a low noise amplifier (LNA), or an antenna. According to an embodiment of the present disclosure, at least one of the cellular module 1921, the Wi-Fi module 1923, the BT module 1925, the GNSS module 1927, or the NFC module 1928 may communicate RF signals through a separate RF module. The subscription identification module 1924 may include, e.g., a card including a SIM, or an embedded SIM, and may contain unique identification information (e.g., an integrated circuit card identifier (ICCID) or subscriber information (e.g., an international mobile subscriber identity (IMSI)).

The memory 1930 (e.g., the memory 1830) may include, e.g., an internal memory 1932 or an external memory 1934. The internal memory 1932 may include at least one of, e.g., a volatile memory (e.g., a dynamic random access memory (DRAM), a static RAM (SRAM), a synchronous dynamic RAM (SDRAM), etc.) or a non-volatile memory (e.g., a one-time programmable read-only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid-state drive (SSD). The external memory 1934 may include a flash drive, e.g., a compact flash (CF) memory, a secure digital (SD) memory, a micro-SD memory, a min-SD memory, an extreme digital (xD) memory, a multi-media card (MMC), or a Memory Stick™. The external memory 1934 may be functionally or physically connected with the touch sensing device 1901 via various interfaces.

For example, the sensor module 1940 may measure a physical quantity or detect a motion state of the touch sensing device 1901, and the sensor module 1940 may convert the measured or detected information into an electric signal. The sensor module 1940 may include at least one of, e.g., a gesture sensor 1940A, a gyro sensor 1940B, an air pressure sensor 1940C, a magnetic sensor 1940D, an acceleration sensor 1940E, a grip sensor 1940F, a proximity sensor 1940G, a color sensor 1940H such as an red-green-blue (RGB) sensor, a bio sensor 1940I, a temperature/humidity sensor 1940J, an illumination sensor 1940K, or an ultraviolet (UV) sensor 1940M. Additionally or alternatively, the sensing module 1940 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 1940 may further include a control circuit for controlling at least one or more of the sensors included in the sensing module. According to an embodiment of the present disclosure, the touch sensing device 1901 may further include a processor configured to control the sensor module 1940 as part of the processor 1910 or separately from the processor 1910, and the electronic device 2701 may control the sensor module 1940 while the processor 1910 is in a sleep mode.

The input device 1950 may include, e.g., a touch panel 1952, a (digital) pen sensor 1954, a key 1956, or an ultrasonic input device 1958. The touch panel 1952 may use at least one of capacitive, resistive, infrared, or ultrasonic methods. The touch panel 1952 may further include a control circuit. The touch panel 1952 may further include a tactile layer and may provide a user with a tactile reaction. The (digital) pen sensor 1954 may include, e.g., a part of a touch panel or a separate sheet for recognition. The key 1956 may include e.g., a physical button, optical key or key pad. The ultrasonic input device 1958 may sense an ultrasonic wave generated from an input tool through a microphone (e.g., the microphone 1988) to identify data corresponding to the sensed ultrasonic wave.

The display 1960 (e.g., the display 1860) may include a panel 1962, a hologram device 1964, a projector 1966, and/or a control circuit for controlling the same. The panel 1962 may be implemented to be flexible, transparent, or wearable. The panel 1962, together with the touch panel 1952, may be configured in one or more modules. According to an embodiment of the present disclosure, the panel 1962 may include a pressure sensor (or pose sensor) that may measure the strength of a pressure by the user's touch. The pressure sensor may be implemented in a single body with the touch panel 1952 or may be implemented in one or more sensors separate from the touch panel 1952. The hologram device 1964 may make three dimensional (3D) images (holograms) in the air by using light interference. The projector 1966 may display an image by projecting light onto a screen. The screen may be, for example, located inside or outside of the touch sensing device 1901. The interface 1970 may include e.g., a HDMI 1972, a USB 1974, an optical interface 1976, or a D-subminiature (D-sub) 1978. The interface 1970 may be included in e.g., the communication interface 1870 shown in FIG. 18. Additionally or alternatively, the interface 1970 may include a mobile high-definition link (MHL) interface, a SD card/MMC interface, or infrared data association (IrDA) standard interface.

The audio module 1980 may convert, e.g., a sound signal into an electric signal and vice versa. At least a part of the audio module 1980 may be included in e.g., the input/output interface 1845 as shown in FIG. 18. The audio module 1980 may process sound information input or output through e.g., a speaker 1982, a receiver 1984, an earphone 1986, or a microphone 1988. For example, the camera module 1991 may be a device for capturing still images and videos, and may include, according to an embodiment of the present disclosure, one or more image sensors (e.g., front and back sensors), a lens, an ISP, or a flash such as an LED or xenon lamp. The power manager module 1995 may manage power of the touch sensing device 1901, for example. According to an embodiment of the present disclosure, the power manager module 1995 may include a power management Integrated circuit (PMIC), a charger IC, or a battery or fuel gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 1996, a voltage, a current, or a temperature while the battery 296 is being charged. The battery 1996 may include, e.g., a rechargeable battery or a solar battery.

The indicator 1997 may indicate a particular state of the touch sensing device 1901 or a part (e.g., the processor 1910) of the electronic device, including e.g., a booting state, a message state, or recharging state. The motor 1998 may convert an electric signal to a mechanical vibration and may generate a vibrational or haptic effect. The touch sensing device 1901 may include a mobile TV supporting device (e.g., a GPU) that may process media data as per, e.g., digital multimedia broadcasting (DMB), digital video broadcasting (DVB), or mediaFlo™ standards. Each of the aforementioned components set forth herein may include one or more parts, and the name of the part may vary with the type of the touch sensing device. According to various embodiments, the touch sensing device (e.g., the touch sensing device 1901) may exclude some elements or include more elements, or some of the elements may be combined into a single entity that may perform the same function as by the elements before combined.

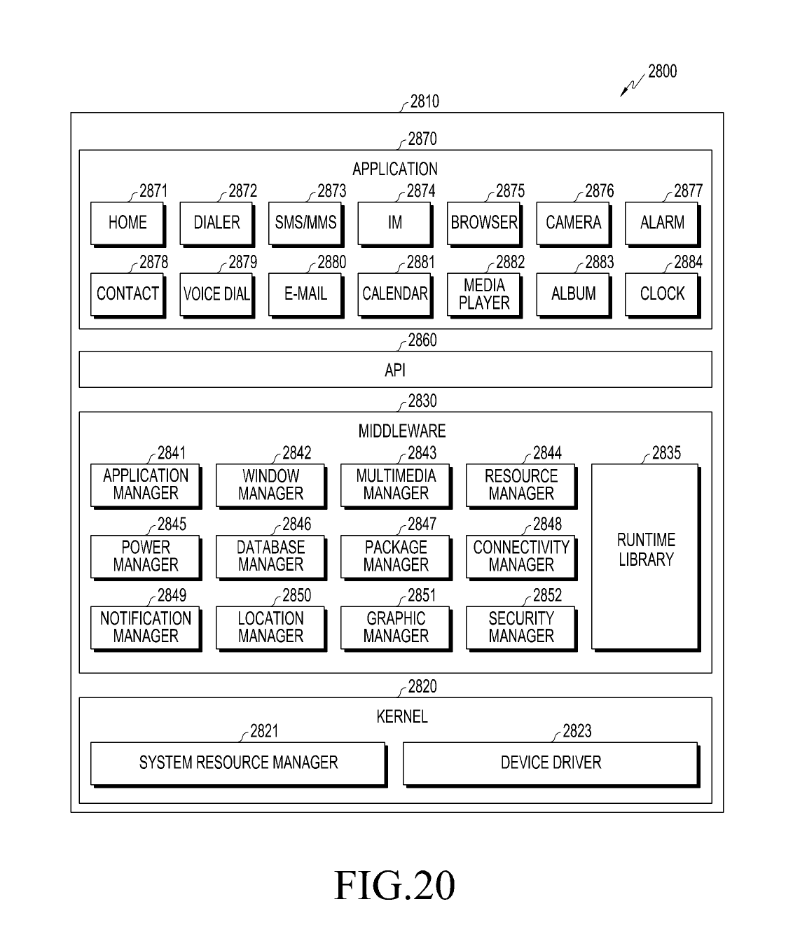

FIG. 20 is a block diagram 2800 illustrating a program module according to an embodiment of the present disclosure.

According to an embodiment of the present disclosure, the program module 2810 (e.g., the program 1840) may include an operating system (OS) controlling resources related to the touch sensing device (e.g., the touch sensing device 1801) and/or various applications (e.g., the application processor 1847) driven on the OS. The OS may include, e.g., Android™, iOS™, Windows™, Symbian™, Tizen™, or Bada™.

Referring to FIG. 20, the program module 2810 may include a kernel 2820 (e.g., the kernel 1841), middleware 2830 (e.g., the middleware 1843), an API 2860 (e.g., the API 1845), and/or an application 2870 (e.g., the application program 1847). At least a part of the program module 2810 may be preloaded on the touch sensing device or may be downloaded from an external touch sensing device (e.g., the touch sensing devices 1802 and 1804 or server 1806).

The kernel 2820 may include, e.g., a system resource manager 2821 or a device driver 2823. The system resource manager 2821 may perform control, allocation, or recovery of system resources. According to an embodiment of the present disclosure, the system resource manager 2821 may include a process managing unit, a memory managing unit, or a file system managing unit. The device driver 2823 may include, e.g., a display driver, a camera driver, a BT driver, a shared memory driver, a USB driver, a keypad driver, a Wi-Fi driver, an audio driver, or an inter-process communication (IPC) driver. The middleware 2830 may provide various functions to the application 2870 through the API 2860 so that the application 2870 may use limited system resources in the touch sensing device or provide functions jointly required by applications 2870. According to an embodiment of the present disclosure, the middleware 2830 may include at least one of a runtime library 2835, an application manager 2841, a window manager 2842, a multimedia manager 2843, a resource manager 2844, a power manager 2845, a database manager 2846, a package manager 2847, a connectivity manager 2848, a notification manager 2849, a location manager 2850, a graphic manager 2851, or a security manager 2852.

The runtime library 2835 may include a library module used by a compiler in order to add a new function through a programming language while, e.g., the application 2870 is being executed. The runtime library 2835 may perform input/output management, memory management, or arithmetic function processing. The application manager 2841 may manage the life cycle of, e.g., the applications 2870. The window manager 2842 may manage GUI resources used on the screen. The multimedia manager 2843 may grasp formats necessary to play media files and use a codec appropriate for a format to perform encoding or decoding on media files. The resource manager 2844 may manage the source code or memory space of the application 2870. The power manager 2845 may manage, e.g., the battery capability or power and provide power information necessary for the operation of the touch sensing device. According to an embodiment of the present disclosure, the power manager 2845 may interwork with a basic input/output system (BIOS). The database manager 2846 may generate, search, or vary a database to be used in the applications 2870. The package manager 2847 may manage installation or update of an application that is distributed in the form of a package file.

The connectivity manager 2848 may manage, e.g., wireless connectivity. The notification manager 2849 may provide an event, e.g., arrival message, appointment, or proximity alert, to the user. The location manager 2850 may manage, e.g., locational information on the touch sensing device. The graphic manager 2851 may manage, e.g., graphic effects to be offered to the user and their related user interface. The security manager 2852 may provide system security or user authentication, for example. According to an embodiment of the present disclosure, the middleware 2830 may include a telephony manager for managing the voice or video call function of the touch sensing device or a middleware module able to form a combination of the functions of the above-described elements. According to an embodiment of the present disclosure, the middleware 2830 may provide a module specified according to the type of the OS. The middleware 2830 may dynamically omit some existing components or add new components. The API 2860 may be a set of, e.g., API programming functions and may have different configurations depending on OSs. For example, in the case of Android™ or iOS™, one API set may be provided per platform, and in the case of Tizen™, two or more API sets may be offered per platform.

The application 2870 may include an application that may provide, e.g., a home 2871, a dialer 2872, an short message service (SMS)/multimedia messaging service (MMS) 2873, an instant message (IM) 2874, a browser 2875, a camera 2876, an alarm 2877, a contact 2878, a voice dial 2879, an email 2880, a calendar 2881, a media player 2882, an album 2883, or a clock 2884, an item related to health care (e.g., measuring the degree of workout or blood sugar), or provision of environmental information (e.g., provision of air pressure, moisture, or temperature information). According to an embodiment of the present disclosure, the application 2870 may include an information exchanging application supporting information exchange between the touch sensing device and a touch sensing device. Examples of the information exchange application may include, but is not limited to, a notification relay application for transferring specific information to the external touch sensing device, or a device management application for managing the external touch sensing device. For example, the notification relay application may transfer notification information generated by other application of the touch sensing device to the external touch sensing device or receive notification information from the external touch sensing device and provide the received notification information to the user. For example, the device management application may install, delete, or update a function (e.g., turn-on/turn-off the external touch sensing device (or some elements) or adjusting the brightness (or resolution) of the display) of the external touch sensing device communicating with the touch sensing device or an application operating on the external touch sensing device. According to an embodiment of the present disclosure, the application 2870 may include an application (e.g., a health-care application of a mobile medical device) designated according to an attribute of the external touch sensing device. According to an embodiment of the present disclosure, the application 2870 may include an application received from the external touch sensing device. At least a portion of the program module 2810 may be implemented (e.g., executed) in software, firmware, hardware (e.g., the processor 1910), or a combination of at least two or more thereof and may include a module, program, routine, command set, or process for performing one or more functions.

According to an embodiment of the present disclosure, a method for operating a touch sensing device for determining a position of a pen may comprise outputting electrical signals from a plurality of electrodes, respectively, of the touch sensing device using a pen signal generated from the pen, determining a type of the pen based on the electrical signals, and measuring the position of the pen by a method corresponding to the determined type of the pen.

According to an embodiment of the present disclosure, determining the type of the pen may include determining the type of the pen based on at least one of a frequency, an amplitude, and a waveform of the electrical signals.

According to an embodiment of the present disclosure, determining the type of the pen may include, upon detecting a reduction in the amplitude of the electrical signals, determining that the type of the pen is a passive pen, and upon failure to detect the reduction in the amplitude of the electrical signals, determining that the type of the pen is an active pen.

According to an embodiment of the present disclosure, determining the type of the pen may include comparing the result of the processing on the electrical signals with the waveform of signals respectively corresponding to the plurality of types of pens and determining the type of the pen based on a result of the comparison.

According to an embodiment of the present disclosure, the method may further comprise determining at least one of a frequency of a signal transmitted to the pen, a period for transmitting the signal to the pen, a period for receiving a signal from the pen, and a method for measuring a pen pressure of the pen according to the determined type of the pen.

According to an embodiment of the present disclosure, determining the at least one of the period for receiving the signal from the pen and the method for measuring the pen pressure of the pen may include determining at least one of a timing, duration, and repetition count of at least one of the period for transmitting the signal to the pen and the period for receiving the signal from the pen.

According to an embodiment of the present disclosure, the method may further comprise determining whether to transmit a signal to the pen depending on the determined type of the pen.

According to an embodiment of the present disclosure, the method may further comprise varying a sensing frequency of the electrical signals depending on the determined type of the pen.

According to an embodiment of the present disclosure, the method may further comprise driving a circuit for determining the position of the determined type of pen and abstaining from using a circuit for determining the position of other types of pens than the determined type of the pen.

According to an embodiment of the present disclosure, determining the type of the pen may include detecting a type of a first-type pen and a second-type pen, determining a position of the first-type pen, and determining a position of the second-type pen independently from the position of the first-type pen.

According to an embodiment of the present disclosure, determining the type of the pen may include dynamically setting an electrode for determining the position of the first-type pen and an electrode for determining the position of the second-type pen to differ from each other.

According to an embodiment of the present disclosure, the method may further comprise abstaining from receiving a signal related to the position of contact of a conductive object by a capacitance variation sensing circuit that senses the contact of the conductive object or determining relevant information.

According to an embodiment of the present disclosure, a method for operating a pen may comprise receiving a signal generated from a touch sensing device through a capacitive coupling with an electrode of the touch sensing device to generate an electrical signal and generating a pen signal corresponding to an electrical signal received from a receiving circuit.

According to an embodiment of the present disclosure, the method may further comprise sensing a pressure applied to the touch sensing device by the pen.

According to an embodiment of the present disclosure, the method may further comprise abstaining from receiving or processing a signal of the touch sensing device during a preset period after the pressure is sensed.

According to an embodiment of the present disclosure, there is provided a storage medium storing commands configured to be executed by at least one processor to enable the at least one processor to perform at least one operation that may include outputting electrical signals from a plurality of electrodes, respectively, using a pen signal generated from the pen, determining a type of the pen based on the electrical signals, and measuring the position of the pen by a method corresponding to the determined type of the pen. Other operations may comprise receiving a signal generated from a touch sensing device through a capacitive coupling with an electrode of the touch sensing device to generate an electrical signal and generating a pen signal corresponding to an electrical signal received from a receiving circuit.

As used herein, the term “module” includes a unit configured in hardware, software, or firmware and may be interchangeably used with other term, e.g., a logic, logic block, part, or circuit. The module may be a single integral part or a minimum unit or part of performing one or more functions. The module may be implemented mechanically or electronically and may include, e.g., an application-specific integrated circuit (ASIC) chip, field-programmable gate arrays (FPGAs), or programmable logic device, that has been known or to be developed in the future as performing some operations. According to an embodiment of the present disclosure, at least a part of the device (e.g., modules or their functions) or method (e.g., operations) may be implemented as instructions stored in a computer-readable storage medium (e.g., the memory 1830), e.g., in the form of a program module. The instructions, when executed by a processor (e.g., the processor 1820), may enable the processor to carry out a corresponding function. The computer-readable medium may include, e.g., a hard disk, a floppy disc, a magnetic medium (e.g., magnetic tape), an optical recording medium (e.g., compact disc-ROM (CD-ROM), DVD, magnetic-optical medium (e.g., floptical disk), or an embedded memory. The instruction may include a code created by a compiler or a code executable by an interpreter. Modules or programming modules in accordance with various embodiments of the present disclosure may include at least one or more of the aforementioned components, omit some of them, or further include other additional components. Operations performed by modules, programming modules or other components in accordance with various embodiments of the present disclosure may be carried out sequentially, in parallel, repeatedly or heuristically, or at least some operations may be executed in a different order or omitted or other operations may be added.

As is apparent from the foregoing description, according to various embodiments of the present disclosure, there may be provided a touch sensing device capable of determining the type of various pens and operating as per the determined type and a method for operating the touch sensing device. There may also be provided a pen capable of determining the type of a touch panel and operating according to the determined type and a method for operating the pen.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A touch sensing device for determining a position of a pen, the touch sensing device comprising:
a plurality of electrodes configured to output electrical signals using an electric field generated from the pen;
a receiving circuit configured to receive the electrical signals from the plurality of electrodes; and
a control circuit configured to:
determine a type of the pen, among a plurality of types of pens, based on the electrical signals received from the receiving circuit, and
measure the position of the pen according to the determined type of the pen.

2. The touch sensing device of claim 1, wherein the control circuit is configured to determine the type of the pen based on at least one of a frequency, an amplitude, or a waveform of the electrical signals.

3. The touch sensing device of claim 2,
wherein the control circuit is further configured to:
determine that the type of the pen is a passive pen, upon detecting a reduction in the amplitude of the electrical signals, and
determine that the type of the pen is an active pen, upon failure to detect the reduction in the amplitude of the electrical signals.

4. The touch sensing device of claim 1,
wherein the receiving circuit comprises a plurality of processors, and
wherein each of the plurality of processors is configured to process the electric signals for each of the plurality of types of pens, respectively.

5. The touch sensing device of claim 4, wherein the receiving circuit comprises:
an amplifier configured to amplify the electrical signals, and
an analog-to-digital converter (ADC) configured to:
convert the amplified signals, and
transmit the converted signals, respectively, to the plurality of processing units.

6. The touch sensing device of claim 4,
wherein the receiving circuit is further configured to, during a first period:
summate the electrical signals from the plurality of electrodes,
transfer the electrical signals to each of the plurality of processors for processing, and
transfer a result of the processing to the control circuit, and
wherein the control circuit is further configured to determine the type of the pen based on the result of the processing.

7. The touch sensing device of claim 6,
wherein the plurality of processors, respectively, is configured to detect respective signals each corresponding to each of the plurality of types of pens, and
wherein the control circuit is further configured to determine the type of the pen corresponding to a first processor among the plurality of processors by selecting the first processor which detects a pen signal from the plurality of processors.

8. The touch sensing device of claim 6,
wherein the receiving circuit is further configured to, during a second period:
transmit the electrical signals from the plurality of electrodes to the plurality of processors, respectively, for processing, and
transfer a result of the processing to the control circuit,
wherein the plurality of processors is configured to process the electrical signals depending on the determined type of the pen, and
wherein the control circuit is further configured to determine the position of the pen based on the result of the processing.

9. The touch sensing device of claim 1, wherein the receiving circuit comprises:
an amplifier configured to amplify the electrical signals,
an analog-to-digital converter (ADC) configured to convert the amplified electrical signals into digital signals,
at least one processor, and
a memory configured to store a waveform of an electrical signal received from the pen,
wherein the control circuit is further configured to store the waveform of the electrical signal received from the pen in the memory in the form of a digital signal processed through the amplifier and the ADC, and
wherein the at least one processor is configured to sequentially determine whether to sense different types of pens by using the waveform of the electrical signal stored in the memory.

10. The touch sensing device of claim 1, wherein the control circuit is further configured to determine at least one of a frequency of a signal transmitted to the pen, a period for transmitting the signal to the pen, a period for receiving a signal from the pen, or a measurement of a pen pressure of the pen depending on the determined type of the pen.

11. The touch sensing device of claim 10, wherein the control circuit is further configured to determine at least one of a timing, duration, or repetition count of at least one of the period for transmitting the signal to the pen or the period for receiving the signal from the pen.

12. The touch sensing device of claim 1, wherein the control circuit is further configured to determine whether to transmit a signal to the pen depending on the determined type of the pen.

13. The touch sensing device of claim 1, wherein the control circuit is further configured to vary a sensing frequency of the receiving circuit depending on the determined type of the pen.

14. The touch sensing device of claim 1, wherein the control circuit is further configured to drive the receiving circuit to determine the position of the determined type of pen alone and abstain from determining the position of other types of pens other than the determined type of the pen.

15. The touch sensing device of claim 1, wherein the control circuit is further configured to:
detect a type of a first-type pen and a second-type pen,
determine a position of the first-type pen, and
determine a position of the second-type pen independently of the position of the first-type pen.

16. The touch sensing device of claim 15, wherein the control circuit is further configured to set electrode areas for sensing the second-type pen depending on whether the first-type pen is sensed.

17. The touch sensing device of claim 1, further comprising:
a capacitance variation sensing circuit configured to sense contact of a conductive object,
wherein the control circuit is further configured to abstain from determining or transmitting information regarding a position of the contact of the conductive object by the capacitance variation sensing circuit during a period when at least one type of pen signal is sensed.

18. A pen comprising:
a receiving electrode configured to receive a signal generated from a touch sensing device through a capacitive coupling with an electrode of the touch sensing device;
a receiving circuit configured to receive an electrical signal of the touch sensing device from the receiving electrode; and
a pen signal generating circuit configured to generate a pen signal of at least one of a pattern or a frequency which has been set according to the electrical signal received from the receiving circuit.

19. The pen of claim 18, further comprising:
a pen pressure sensing circuit configured to sense a pressure applied by the pen to the touch sensing device.

20. The pen of claim 19, wherein the receiving circuit is further configured to abstain from receiving or processing an electrical signal of the touch sensing device during a preset period after the pen pressure is sensed by the pen pressure sensing circuit.
